(19) United States
(12) Patent Application Publication
(10) Pub. No.: US 2025/0379624 A1
(43) Pub. Date: Dec. 11, 2025

(54) CONFIGURING RESOURCES FOR BEAM REPORTING IN WIRELESS COMMUNICATION SYSTEMS

(71) Applicant: Samsung Electronics Co., Ltd., Suwon-si (KR)

(72) Inventors: Anil Agiwal, McKinney, TX (US); Shiyang Leng, Little Elm, TX (US); Kyeongin Jeong, Frisco, TX (US)

(21) Appl. No.: 19/200,563

(22) Filed: May 6, 2025

Related U.S. Application Data
(60) Provisional application No. 63/656,228, filed on Jun. 5, 2024.
(60) Provisional application No. 63/692,909, filed on Sep. 10, 2024.
(60) Provisional application No. 63/695,127, filed on Sep. 16, 2024.
(60) Provisional application No. 63/771,423, filed on Mar. 13, 2025.

(51) Int. Cl. H04B 7/06; H04W 72/21

(52) U.S. Cl. CPC H04B 7/0626; H04W 72/21

(57) ABSTRACT

A UE includes a processor, and a transceiver operably coupled to the processor. The transceiver is configured to transmit, to a serving cell, a message indicating that the UE supports CSI acquisition for LTM. The transceiver is also configured to receive, from the serving cell, a configuration message including an LTM configuration for one or more LTM candidate cells, a list of one or more LTM CSI resource configurations for early CSI acquisition of one or more LTM candidate cells, and a list of one or more LTM CSI reporting configurations for early CSI reporting. The transceiver is also configured to receive, from the serving cell, early CSI request information for an LTM candidate cell of the one or more LTM candidate cells, and transmit, to one of the serving cell or the LTM candidate cell, CSI acquired based on the early CSI request information.

### CROSS-REFERENCE TO RELATED APPLICATIONS AND CLAIM OF PRIORITY

This application claims priority under 35 U.S.C. § 119 (e) to U.S. Provisional Patent Application No. 63/656,228 filed on Jun. 5, 2024, U.S. Provisional Patent Application No. 63/692,909 filed on Sep. 10, 2024, U.S. Provisional Patent Application No. 63/695,127 filed on Sep. 16, 2024, and U.S. Provisional Patent Application No. 63/771,423 filed on Mar. 13, 2025. The above-identified provisional patent applications are hereby incorporated by reference in their entirety.

### TECHNICAL FIELD

This disclosure relates generally to wireless networks. More specifically, this disclosure relates to configuring resources for beam reporting in wireless communication systems.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveforms (e.g., new radio access technologies [RATs]) to flexibly accommodate various services/applications with different requirements, new multiple access schemes to support massive connections, etc.

### SUMMARY

This disclosure provides apparatuses and methods for beam reporting in wireless communication systems.

In one embodiment, a user equipment (UE) is provided. The UE includes a processor, and a transceiver operably coupled to the processor. The transceiver is configured to transmit, to a serving cell, a message indicating that the UE supports early channel state information (CSI) acquisition for layer one triggered mobility (LTM). The transceiver is also configured to receive, from the serving cell, a configuration message including an LTM configuration for one or more LTM candidate cells, a list of one or more LTM CSI resource configurations for early CSI acquisition of one or more LTM candidate cells, and a list of one or more LTM CSI reporting configurations for early CSI reporting. The transceiver is also configured to receive, from the serving cell, early CSI request information for an LTM candidate cell of the one or more LTM candidate cells, and transmit, to one of the serving cell or the LTM candidate cell, CSI acquired based on the early CSI request information.

In another embodiment, a base station (BS) is provided. The BS includes a processor, and a transceiver operably coupled to the processor. The transceiver is configured to receive, from a UE, a message indicating that the UE supports early CSI acquisition for LTM. The transceiver is also configured to transmit, to the UE a configuration message including an LTM configuration for one or more LTM candidate cells, a list of one or more LTM CSI resource configurations for early CSI acquisition of one or more LTM candidate cells, and a list of one or more LTM CSI reporting configurations for early CSI reporting. The transceiver is also configured to transmit, to the UE, early CSI request information for an LTM candidate cell of the one or more LTM candidate cells.

In yet another embodiment, a method of operating a UE is provided. The method includes transmitting, to a serving cell, a message indicating that the UE supports early CSI acquisition for LTM. The method also includes receiving from the serving cell, a configuration message including an LTM configuration for one or more LTM candidate cells, a list of one or more LTM CSI resource configurations for early CSI acquisition of one or more LTM candidate cells, and a list of one or more LTM CSI reporting configurations for early CSI reporting. The method also includes receiving, from the serving cell, early CSI request information for an LTM candidate cell of the one or more LTM candidate cells, and transmitting, to one of the serving cell or the LTM candidate cell, CSI acquired based on the early CSI request information.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example procedure for LTM according to embodiments of the present disclosure;

FIG. 5 illustrates an example procedure for UE initiated/event triggered beam reporting according to embodiments of the present disclosure;

FIG. 6 illustrates another example procedure for UE initiated/event triggered beam reporting according to embodiments of the present disclosure;

FIG. 7 illustrates another example procedure for UE initiated/event triggered beam reporting according to embodiments of the present disclosure;

FIG. 8 illustrates another example procedure for UE initiated/event triggered beam reporting according to embodiments of the present disclosure;

FIG. 9 illustrates an example procedure for CSI reporting/acquisition during a lower layer triggered mobility procedure;

FIG. 10 illustrates an example method for configuring resources for beam reporting according to embodiments of the present disclosure; and

FIG. 11 illustrates another example method for configuring resources for beam reporting according to embodiments of the present disclosure.

### DETAILED DESCRIPTION

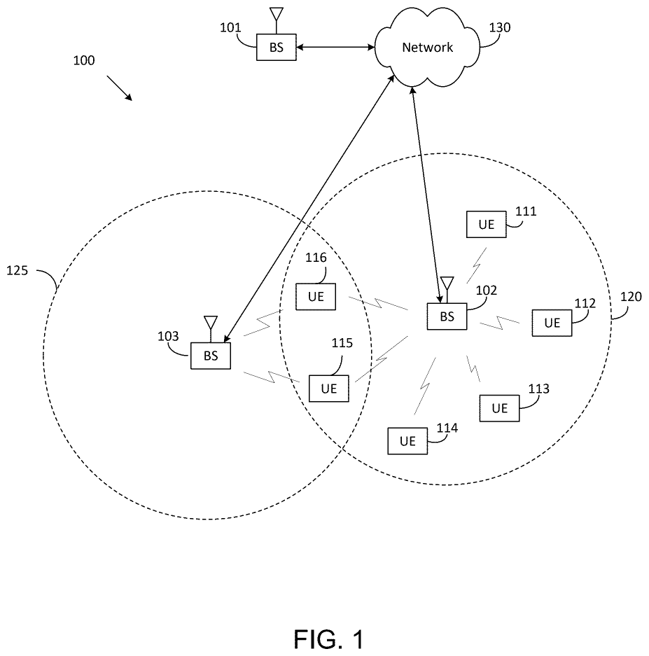

FIGS. 1 through 11, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for beam reporting in wireless communication systems. In certain embodiments, one or more of the gNBs 101-103 includes circuitry, programing, or a combination thereof, to support beam reporting in wireless communication systems.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

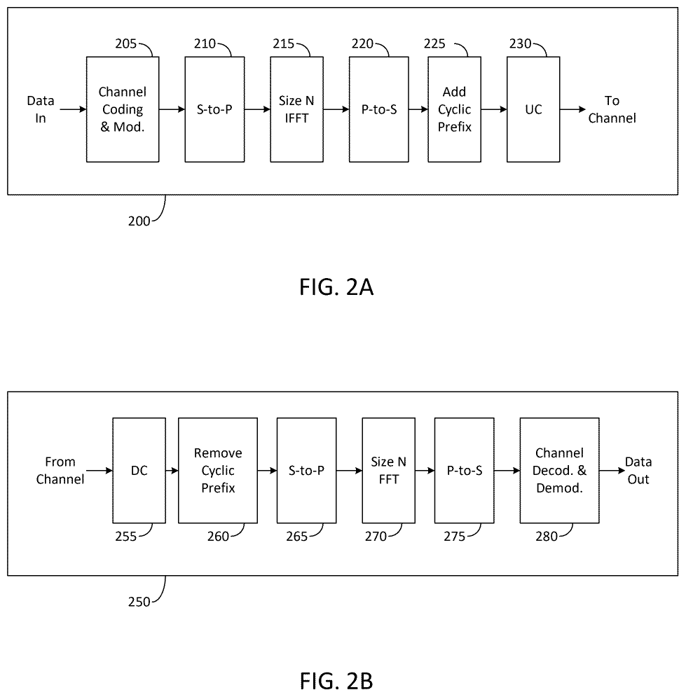

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support beam reporting in wireless communication systems as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

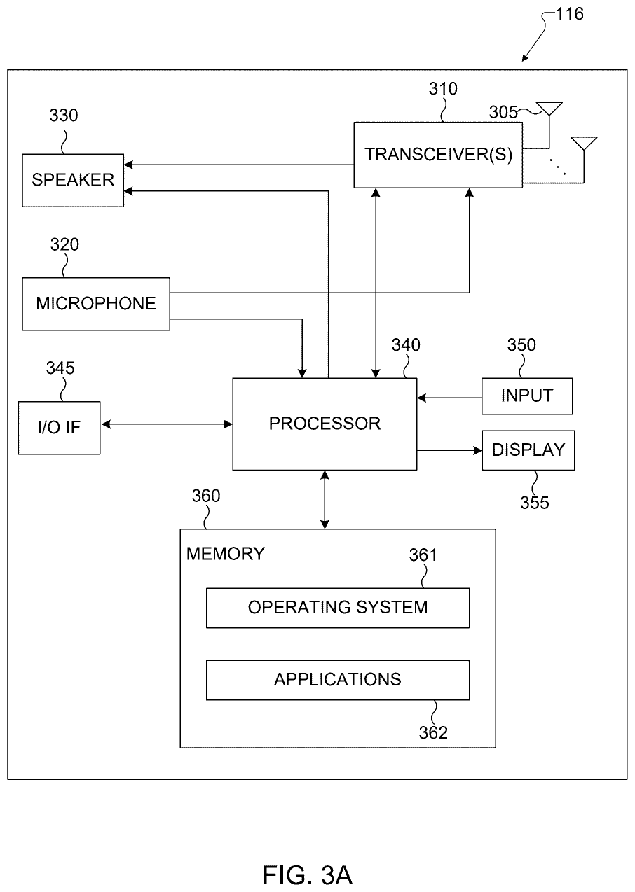

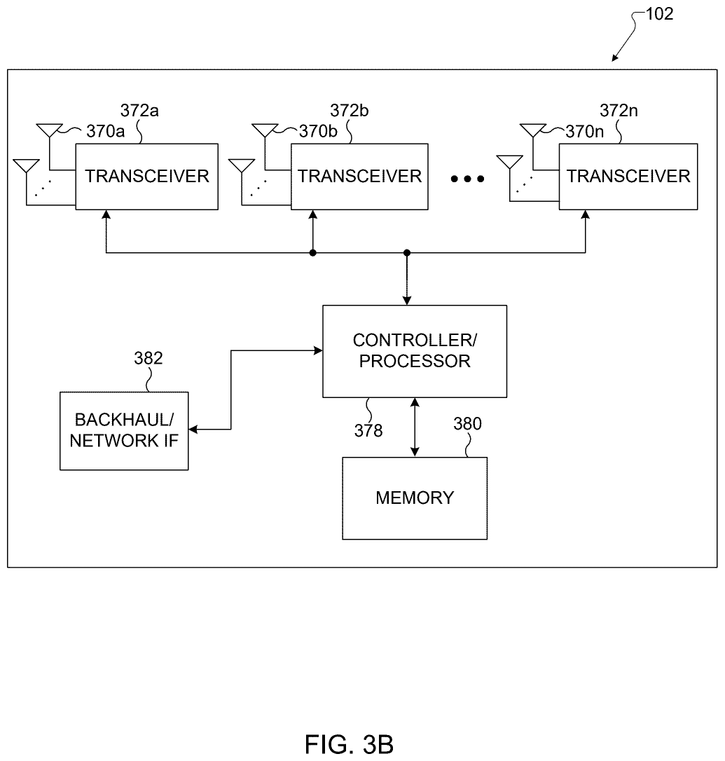

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for beam reporting in wireless communication systems as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support beam reporting in wireless communication systems as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

In the next generation wireless communication system (e.g., 5G, beyond 5G, 6G) operating in higher frequency (mmWave) bands, UEs and gNBs communicate with each other using beamforming. Beamforming techniques are used to mitigate propagation path losses and to increase the propagation distance for communication at higher frequency bands. Beamforming enhances transmission and reception performance using a high-gain antenna. Beamforming can be classified into transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in an increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. RX beamforming increases the RX signal strength transmitted in a specific direction by allowing propagation to be concentrated in a specific direction and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can be also referred to as a TX beam. Wireless communication systems operating at high frequency use a plurality of narrow TX beams to transmit signals in the cell, as each narrow TX beam provides coverage to a part of the cell. The narrower the TX beam, the higher the antenna gain and hence the larger the propagation distance of a signal transmitted using beamforming. A receiver can also generate a plurality of RX beam patterns of different directions. Each of these receive patterns can also be referred to as an RX beam.

The next generation wireless communication system (e.g., 5G, beyond 5G, 6G) supports standalone modes of operation as well dual connectivity (DC). In DC a multiple Rx/Tx UE may be configured to utilize resources provided by two different nodes (or NBs) connected via non-ideal backhaul. One node acts as the Master Node (MN) and the other nodes acts as the Secondary Node (SN). The MN and SN are connected via a network interface and at least the MN is connected to the core network. NR also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with carrier aggregation (CA)/DC there is only one serving cell comprising the primary cell. For a UE in an RRC_CONNECTED state configured with CA/DC the term ‘serving cells’ is used to denote the set of cells comprising the Special Cell(s) (SpCell[s]) and all secondary cells (SCells). In NR the term Master Cell Group (MCG) refers to a group of serving cells associated with the Master Node, comprising the primary cell (PCell) and optionally one or more (SCells. In NR the term Secondary Cell Group (SCG) refers to a group of serving cells associated with the Secondary Node, comprising the primary SCG cell (PSCell) and optionally one or more SCells. In NR, PCell refers to a serving cell in a MCG, operating on the primary frequency, in which the UE either performs the initial connection establishment procedure or initiates the connection re-establishment procedure. In NR, for a UE configured with CA, an SCell is a cell providing additional radio resources on top of the SpCell. PSCell refers to a serving cell in a SCG in which the UE performs random access when performing the Reconfiguration with Sync procedure. For Dual Connectivity operation the term SpCell refers to the PCell of the MCG or the PSCell of the SCG. Otherwise, the term SpCell refers to the PCell.

In the next generation wireless communication system (e.g., 5G, beyond 5G, 6G), a next generation node B (gNB) or base station in cell broadcast Synchronization Signal and physical broadcast channel (PBCH) block (SSB) comprises primary and secondary synchronization signals (PSS, SSS) and system information (SI). SI includes common parameters needed to communicate in cell. In the fifth generation wireless communication system (also referred to as next generation radio or NR), SI is divided into the master information block (MIB) and a number of s (SIBs) where: the MIB is always transmitted on the broadcast channel (BCH) with a periodicity of 80 ms and repetitions made within 80 ms and the MIB includes parameters that are used to acquire SIB1 from the cell. The SIB1 is transmitted on the downlink shared channel (DL-SCH) with a periodicity of 160 ms and variable transmission repetition. The default transmission repetition periodicity of SIB1 is 20 ms but the actual transmission repetition periodicity is up to network implementation. For SSB and CORESET multiplexing pattern 1, the SIB1 repetition transmission period is 20 ms. For SSB and CORESET multiplexing pattern 2/3, the SIB1 transmission repetition period is the same as the SSB period. SIB1 includes information regarding the availability and scheduling (e.g., mapping of SIBs to SI messages, periodicity, SI-window size) of other SIBs with an indication whether one or more SIBs are only provided on-demand and, in that case, the configuration needed by the UE to perform the SI request. SIB1 is a cell-specific SIB. SIBs other than SIB1 and posSIBs are carried in SystemInformation (SI) messages, which are transmitted on the DL-SCH. Only SIBs or positioning SIBs (posSIBs) having the same periodicity can be mapped to the same SI message. SIBs and posSIBs are mapped to the different SI messages. Each SI message is transmitted within periodically occurring time domain windows (referred to as SI-windows with the same length for all SI messages). Each SI message is associated with an SI-window and the SI-windows of different SI messages do not overlap. That is to say, within one SI-window only the corresponding SI message is transmitted. An SI message may be transmitted a number of times within the SI-window. Any SIB or posSIB except SIB1 can be configured to be cell specific or area specific, using an indication in the SIB1. A cell specific SIB is applicable only within a cell that provides the SIB while an area specific SIB is applicable within an area referred to as an SI area, which comprises one or several cells and is identified by systemInformationAreaID. The mapping of SIBs to SI messages is configured in schedulingInfoList, while the mapping of posSIBs to SI messages is configured in pos-SchedulingInfoList. Each SIB is contained only in a single SI message and each SIB and posSIB is contained at most once in that SI message. For a UE in an RRC_CONNECTED state, the network can provide system information through dedicated signaling using an RRCReconfiguration message (e.g., if the UE has an active BWP with no common search space configured to monitor system information), paging, or upon request from the UE. In an RRC_CONNECTED state, the UE acquires the required SIB(s) only from the PCell. For PSCell and SCells, the network provides the required SI by dedicated signaling (i.e., within an RRCReconfiguration message). Nevertheless, the UE shall acquire the MIB of the PSCell to get system frame number (SFN) timing of the SCG (which may be different from MCG). Upon a change of relevant SI for the SCell, the network releases and adds the concerned SCell. For the PSCell, the required SI can only be changed with Reconfiguration with Sync.

In the next generation wireless communication system (e.g., 5G, beyond 5G, 6G), A physical downlink control channel (PDCCH) is used to schedule DL transmissions on a physical downlink shared channel (PDSCH) and UL transmissions on a physical uplink shared channel (PUSCH), where Downlink Control Information (DCI) on the PDCCH includes: downlink assignments containing at least modulation and coding format, resource allocation, and hybrid-ARQ information related to DL-SCH; and uplink scheduling grants containing at least modulation and coding format, resource allocation, and hybrid-ARQ information related to UL-SCH. In addition to scheduling, the PDCCH can be used to for: activation and deactivation of configured PUSCH transmission with configured grant; activation and deactivation of PDSCH semi-persistent transmission; notifying one or more UEs of the slot format; notifying one or more UEs of the physical resource block(s) (PRB[s]) and OFDM symbol(s) where the UE may assume no transmission is intended for the UE; transmission of transmit power control (TPC) commands for the physical uplink control channel (PUCCH) and PUSCH; transmission of one or more TPC commands for sounding reference signal (SRS) transmissions by one or more UEs; switching a UE's active bandwidth part; and initiating a random access procedure. A UE monitors a set of PDCCH candidates in the configured monitoring occasions in one or more configured Control REsource SETs (CORESETs) according to the corresponding search space configurations. A CORESET comprises a set of PRBs with a time duration of 1 to 3 OFDM symbols. The resource units Resource Element Groups (REGs) and Control Channel Elements (CCEs) are defined within a CORESET with each CCE comprising a set of REGs. Control channels are formed by aggregation of CCEs. Different code rates for the control channels are realized by aggregating a different number of CCEs. Interleaved and non-interleaved CCE-to-REG mappings are supported in a CORESET. Polar coding is used for the PDCCH. Each resource element group carrying the PDCCH carries its own demodulation reference signal (DMRS). Quadrature phase shift keying (QPSK) modulation is used for the PDCCH.

In the next generation wireless communication system (e.g., 5G, beyond 5G, 6G), a list of search space configurations is signaled by the gNB for each configured BWP of the serving cell, wherein each search configuration is uniquely identified by a search space identifier. Each search space identifier is unique amongst the BWPs of a serving cell. An identifier of a search space configuration to be used for a specific purpose such as paging reception, SI reception, random access response reception, etc. is explicitly signaled by the gNB for each configured BWP. In NR, a search space configuration comprises the parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are in slots ‘x’ to x+duration, where the slot with number ‘x’ in a radio frame with number ‘y’ satisfies the equation below: (y*(number of slots in a radio frame)+x−Monitoring-offset-PDCCH-slot) mod (Monitoring-periodicity-PDCCH-slot)=0.

The starting symbol of a PDCCH monitoring occasion in each slot having a PDCCH monitoring occasion is given by Monitoring-symbols-PDCCH-within-slot. The length (in symbols) of a PDCCH monitoring occasion is given in the CORESET associated with the search space. The search space configuration includes the identifier of the CORESET configuration associated with it. A list of CORESET configurations is signaled by the gNB for each configured BWP of the serving cell, wherein each CORESET configuration is uniquely identified by a CORESET identifier. A CORESET identifier is unique amongst the BWPs of a serving cell. Note that each radio frame is of 10 ms duration. A radio frame is identified by a radio frame number or system frame number. Each radio frame comprises several slots, wherein the number of slots in a radio frame and duration of slots depends on sub carrier spacing (SC). The number of slots in a radio frame and duration of slots depends on radio frame for each supported SCS is pre-defined in NR. Each CORESET configuration is associated with a list of Transmission configuration indicator (TCI) states. One DL reference signal (RS) identification (ID) (SSB or channel state information [CSI] RS) is configured per TCI state. The list of TCI states corresponding to a CORESET configuration is signaled by the gNB via radio resource control (RRC) signaling. One of the TCI states in a TCI state list is activated and indicated to the UE by the gNB. The TCI state indicates the DL TX beam (the DL TX beam is quasi co-located [QCLed] with the SSB/CSI RS of the TCI state) used by the gNB for transmission of the PDCCH in the PDCCH monitoring occasions of a search space.

In the next generation wireless communication system (e.g., 5G, beyond 5G, 6G), bandwidth adaptation (BA) is supported. With BA, the receive and transmit bandwidth of a UE need not be as large as the bandwidth of the cell and can be adjusted: the width can be ordered to change (e.g., to shrink during a period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring an RRC connected UE with BWP(s) and telling the UE which of the configured BWPs is currently the active one. When BA is configured, the UE can monitor the PDCCH only on the one active BWP (i.e., the does not have to monitor the PDCCH on the entire DL frequency of the serving cell). In an RRC connected state, the UE is configured with one or more DL and UL BWPs, for each configured Serving Cell (i.e., PCell or SCell). For an activated Serving Cell, there is always one active UL and DL BWP at any point in time. BWP switching for a Serving Cell is used to activate an inactive BWP and deactivate an active BWP at a particular moment in time. BWP switching is controlled by the PDCCH indicating a downlink assignment or an uplink grant, by the bwp-InactivityTimer, by RRC signaling, or by the MAC entity itself upon initiation of a random-access procedure. Upon addition of a SpCell or activation of an SCell, the DL BWP and UL BWP indicated by firstActiveDownlinkBWP-Id and firstActiveUplinkBWP-Id respectively is active without receiving a PDCCH indicating a downlink assignment or an uplink grant. The active BWP for a Serving Cell is indicated by either RRC or the PDCCH. For unpaired spectrum, a DL BWP is paired with a UL BWP, and BWP switching is common for both the UL and DL. Upon expiry of the BWP inactivity timer, the UE switches the active DL BWP to the default DL BWP or initial DL BWP (if a default DL BWP is not configured).

In the next generation wireless communication system (e.g., 5G, beyond 5G, 6G), random access (RA) is supported. RA is used to achieve UL time synchronization. RA is used during initial access, handover, RRC connection re-establishment procedure, scheduling request transmission, SCG addition/modification, beam failure recovery and data or control information transmission in the UL by a non-synchronized UE in an RRC_CONNECTED state. Several types of RA procedures are supported, such as contention based random access, and contention free random access. Each of these can be one of 2 step or 4 step random access.

In contention based random access (CBRA), also referred to as 4 step CBRA, the UE first transmits a random access preamble (also referred to as a Msg1) and then waits for a random access response (RAR) in the RAR window. The RAR is also referred to as a Msg2. The gNB transmits the RAR on a PDSCH. A PDCCH scheduling the PDSCH carrying the RAR is addressed to an RA-radio network temporary identifier (RA-RNTI). The RA-RNTI identifies the time-frequency resource (also referred to as a physical RA channel [PRACH] occasion or PRACH TX occasion or RA channel [RACH] occasion) in which the RA preamble was detected by the gNB. The RA-RNTI is calculated as follows: RA-RNTI=1+s_id+14*t_id+14*80*f_id+14*80*8*ul_carrier_id, where s_id is the index of the first OFDM symbol of the PRACH occasion where the UE has transmitted the Msg1 (i.e., RA preamble); 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for the Msg1 transmission (0 for the NUL carrier and 1 for the SUL carrier). Several RARs for various Random-access preambles detected by the gNB can be multiplexed in the same RAR media access control (MAC) protocol data unit (PDU) by gNB. A RAR in a MAC PDU corresponds to the UE's RA preamble transmission if the RAR includes an RA preamble identifier (RAPID) of RA preamble transmitted by the UE. If the RAR corresponding to the UE's RA preamble transmission is not received during the RAR window and the UE has not yet transmitted the RA preamble for a configurable (configured by the gNB in a RACH configuration) number of times, the UE goes back to the first step (i.e., the UE selects a random access resource [preamble/RACH occasion] and transmits the RA preamble). A backoff may be applied before going back to first step.

If the RAR corresponding to the UE's RA preamble transmission is received the UE transmits a Msg3 in the UL grant received in the RAR. The Msg3 includes a message such as an RRC connection request, RRC connection re-establishment request, RRC handover confirm, scheduling request, SI request etc. The Msg3 may include the UE identity (i.e., cell-radio network temporary identifier [C-RNTI] or system architecture evolution [SAE]-temporary mobile subscriber identity [S-TMSI] or a random number). After transmitting the Msg3, The UE starts a contention resolution timer. While the contention resolution timer is running, if the UE receives a PDCCH addressed to the C-RNTI included in the Msg3, contention resolution is considered successful, the contention resolution timer is stopped, and the RA procedure is completed. While the contention resolution timer is running, if the UE receives a contention resolution MAC control element (CE) including the UE's contention resolution identity (the first X bits of a common control channel [CCCH] service data unit [SDU] transmitted in the Msg3), contention resolution is considered successful, the contention resolution timer is stopped, and the RA procedure is completed. If the contention resolution timer expires and the UE has not yet transmitted the RA preamble for a configurable number of times, the UE goes back to the first step (i.e., the UE selects a random access resource [preamble/RACH occasion] and transmits the RA preamble). A backoff may be applied before going back to first step.

Contention free random access (CFRA), also referred to as legacy CFRA or 4 step CFRA, is used for scenarios such as handover where low latency is required, timing advance establishment for secondary cell (Scell), etc. An Evolved node B (eNB) assigns to the UE a dedicated random access preamble. The UE transmits the dedicated RA preamble. The eNB transmits the RAR on a PDSCH addressed to an RA-RNTI. The RAR conveys the RA preamble identifier and timing alignment information. The RAR may also include an UL grant. The RAR is transmitted in a RAR window similar to contention-based RA (CBRA) procedure. The CFRA is considered successfully completed after receiving the RAR including the RA preamble identifier (RAPID) of the RA preamble transmitted by the UE. In case the RA is initiated for beam failure recovery, the CFRA is considered successfully completed if a PDCCH addressed to a C-RNTI is received in the search space for beam failure recovery. If the RAR window expires and the RA is not successfully completed and the UE has not yet transmitted the RA preamble for a configurable (configured by the gNB in a RACH configuration) number of times, the UE retransmits the RA preamble.

For certain events such as handover and beam failure recovery if dedicated preamble(s) are assigned to UE, during first step of random access (i.e., during random access resource selection for Msg1 transmission) the UE determines whether to transmit a dedicated preamble or non-dedicated preamble. Dedicated preambles are typically provided for a subset of SSBs/CSI RSs. If there are no SSB/CSI RS having a DL RSRP above a threshold amongst the SSBs/CSIRSs for which contention free random access resources (i.e., dedicated preambles/ROs) are provided by the gNB, the UE selects a non-dedicated preamble. Otherwise, the UE selects a dedicated preamble. During the RA procedure, one random access attempt can be CFRA while other random access attempts can be CBRA.

For 2 step contention based random access (2 step CBRA), in the first step, the UE transmits a random access preamble on a PRACH and a payload (i.e., MAC PDU) on a PUSCH. The random access preamble and payload transmission is also referred to as a message A (MsgA). In the second step, after the MsgA transmission, the UE monitors for a response from the network (i.e., a gNB) within a configured window. The response is also referred to as a message B (MsgB). A gNB transmits the MsgB on a PDSCH. A PDCCH scheduling the PDSCH carrying the MsgB is addressed to a MsgB-radio network temporary identifier (MSGB-RNTI). The MSGB-RNTI identifies the time-frequency resource (also referred to as a PRACH occasion or PRACH TX occasion or RACH occasion) in which the RA preamble was detected by the gNB. The MSGB-RNTI is calculated as follows: RA-RNTI=1+s_id+14*t_id+14*80*f_id+14*80*8*ul_carrier_id+14×80×8×2, where s_id is the index of the first OFDM symbol of the PRACH occasion where UE has transmitted the MsgA (i.e., RA preamble); 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for NUL carrier and 1 for SUL carrier).

If a CCCH SDU was transmitted in the MsgA payload, the UE performs contention resolution using the contention resolution information in the MsgB. The contention resolution is successful if the contention resolution identity received in the MsgB matches the first 48 bits of the CCCH SDU transmitted in the MsgA. If a C-RNTI was transmitted in the MsgA payload, the contention resolution is successful if the UE receives a PDCCH addressed to the C-RNTI. If contention resolution is successful, the random access procedure is considered successfully completed. Instead of contention resolution information corresponding to the transmitted MsgA, the MsgB may include fallback information corresponding to the random access preamble transmitted in the MsgA. If the fallback information is received, the UE transmits a Msg3 and performs contention resolution using a Msg4 as in CBRA procedure. If the contention resolution is successful, the random access procedure is considered successfully completed. If the contention resolution fails upon fallback (i.e., upon transmitting the Msg3), the UE retransmits the MsgA. If the configured window in which the UE monitors for a network response after transmitting the MsgA expires and the UE has not received a MsgB including contention resolution information or fallback information as explained above, the UE retransmits MsgA. If the random access procedure is not successfully completed even after transmitting the MsgA configurable number of times, the UE falls back to the 4 step RACH procedure (i.e., the UE only transmits the PRACH preamble).

A MsgA payload may include one or more of a CCCH SDU, dedicated control channel (DCCH) SDU, dedicated traffic channel (DTCH) SDU, buffer status report (BSR) MAC control element (CE), power headroom report (PHR) MAC CE, SSB information, C-RNTI MAC CE, or padding. The MsgA may include a UE ID (e.g., a random ID, S-TMSI, C-RNTI, resume ID, etc.) along with a preamble in the first step. The UE ID may be included in the MAC PDU of the MsgA. AUE ID such as a C-RNTI may be carried in the MAC CE, wherein the MAC CE is included in The MAC PDU. Other UE IDs (such as a random ID, S-TMSI, C-RNTI, resume ID, etc.) may be carried in a CCCH SDU. The UE ID can be one of a random ID, S-TMSI, C-RNTI, resume ID, IMSI, idle mode ID, inactive mode ID, etc. The UE ID can be different in different scenarios in which the UE performs the RA procedure. When the UE performs RA after power on (before the UE is attached to the network), then the UE ID is the random ID. When the UE performs an RA in an IDLE state after the UE is attached to network, the UE ID is an S-TMSI. If the UE has an assigned C-RNTI (e.g., in a connected state), the UE ID is the C-RNTI. In case the UE is in an INACTIVE state, the UE ID is a resume ID. In addition to the UE ID, some addition control information can be sent in a MsgA. The control information may be included in the MAC PDU of the MsgA. The control information may include one or more of a connection request indication, connection resume request indication, SI request indication, buffer status indication, beam information (e.g., one or more DL TX beam ID[s] or SSB ID[s]), beam failure recovery indication/information, data indicator, cell/BS/TRP switching indication, connection re-establishment indication, reconfiguration complete or handover complete message, etc.

In the case of 2 step contention free random access (2 step CFRA), the gNB assigns to the UE dedicated random access preamble(s) and PUSCH resource(s) for MsgA transmission. RACH occasions (ROs) to be used for preamble transmission may also be indicated. In the first step, the UE transmits a random access preamble on a PRACH and a payload on a PUSCH using the contention free random access resources (i.e., dedicated preamble/PUSCH resource/RO). In the second step, after the MsgA transmission, the UE monitors for a response from the network (i.e., gNB) within a configured window. The response is also referred to as a MsgB.

A gNB transmits the MsgB on a PDSCH. A PDCCH scheduling the PDSCH carrying the MsgB is addressed to a MsgB-radio network temporary identifier (MSGB-RNTI). The MSGB-RNTI identifies the time-frequency resource (also referred to as a PRACH occasion or PRACH TX occasion or RACH occasion) in which the RA preamble was detected by the gNB. The MSGB-RNTI is calculated as follows: RA-RNTI=1+s_id+14*t_id+14*80*f_id+14*80*8*ul_carrier_id+14×80×8×2, where s_id is the index of the first OFDM symbol of the PRACH occasion where the UE has transmitted the Msg1 (i.e., RA preamble); 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for an NUL carrier and 1 for an SUL carrier).

If the UE receives a PDCCH addressed to the C-RNTI, the random access procedure is considered successfully completed. If the UE receives fallback information corresponding to its transmitted preamble, the random access procedure is considered successfully completed.

Layer one (L1)/layer two (L2) triggered mobility, also referred to herein as lower layer triggered mobility (LTM), is a procedure in which a gNB receives L1 measurement report(s) from a UE, and on the basis of the L1 measurement report(s) the gNB changes the UE's serving cell by a cell switch command signaled via a MAC CE. The cell switch command indicates an LTM candidate cell configuration that the gNB previously prepared and provided to the UE through RRC signaling. Then the UE switches to the target cell according to the cell switch command. The LTM procedure can be used to reduce mobility latency. The network may request the UE to perform early timing advance (TA) acquisition of a candidate cell before a cell switch. The early TA acquisition is triggered by a PDCCH order or through a UE-based TA measurement.

The network indicates in the cell switch command whether the UE shall access the target cell with a random access (RA) procedure if a TA value is not provided or with a PUSCH transmission using the indicated TA value. For random access channel (RACH) less LTM, the UE accesses the target cell via the configured grant (CG) provided in the RRC signaling and selects the CG occasion associated with the beam indicated in the cell switch command. If the UE does not receive the configured grant in the RRC signaling, the UE monitors PDCCH for dynamic scheduling from the target cell upon LTM cell switch. Before RACH-less LTM procedure completion, the UE shall not trigger random access procedure if it does not have a valid PUCCH resource for triggered SRs.

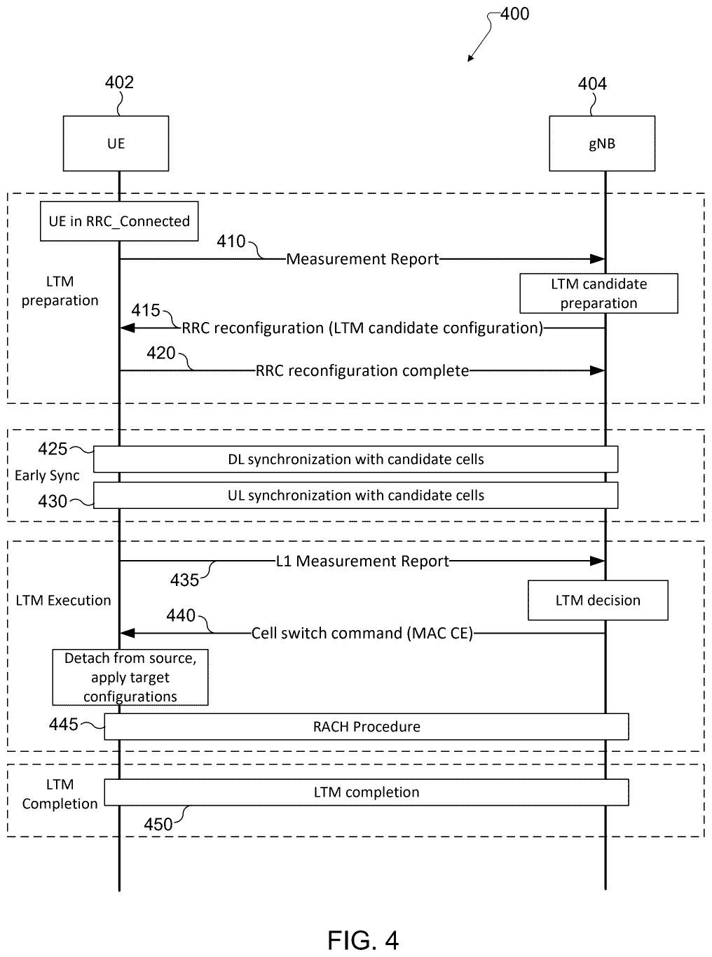

FIG. 4 illustrates an example procedure 400 for LTM according to embodiments of the present disclosure. An embodiment of the method illustrated in FIG. 4 is for illustration only. One or more of the components illustrated in FIG. 4 may be implemented in specialized circuitry configured to perform the noted functions or one or more of the components may be implemented by one or more processors executing instructions to perform the noted functions. Other embodiments of a procedure for LTM could be used without departing from the scope of this disclosure.

In the example of FIG. 4, procedure 400 begins at step 410. At step 410, UE 402 sends a MeasurementReport message to gNB 404. gNB 404 then decides to configure LTM and initiates candidate cell(s) preparation.

At step 415, gNB 404 transmits an RRCReconfiguration message to UE 402 including the LTM candidate cell configurations of one or multiple candidate cells.

At step 420, UE 402 stores the LTM candidate cell configurations and transmits an RRCReconfigurationComplete message to gNB 404.

At step 425, UE 402 may perform DL synchronization with candidate cell(s) before receiving a cell switch command.

At step 430, if requested by the network, UE 402 performs early TA acquisition with candidate cell(s) before receiving the cell switch command. This is done via contention free random access (CFRA) triggered by a PDCCH order from the source cell, following which UE 402 sends a preamble towards the indicated candidate cell. In order to minimize the data interruption of the source cell due to the CFRA towards the candidate cell(s), UE 402 doesn't receive a RAR for the purpose of TA value acquisition and the TA value of the candidate cell is indicated in the cell switch command. UE 402 doesn't maintain the TA timer for the candidate cell and relies on network implementation to guarantee the TA validity.

At step 435, UE 402 performs L1 measurements on the configured candidate cell(s) and transmits L1 measurement reports to the gNB.

At step 440, gNB 404 decides to execute cell switch to a target cell and transmits a MAC CE triggering cell switch by including the candidate configuration index of the target cell. UE 402 switches to the target cell and applies the configuration indicated by the candidate configuration index.

At step 445, UE 402 performs a random access procedure towards the target cell if UE does not have valid TA of the target cell.

At step 450, UE 402 completes the LTM cell switch procedure by sending a RRCReconfigurationComplete message to the target cell. If UE 402 has performed a RA procedure in step 445, UE 402 considers that the LTM execution is successfully completed when the random access procedure is successfully completed. For RACH-less LTM, UE 402 considers that the LTM execution is successfully completed when the UE determines that the network has successfully received its first UL data. UE 402 determines successful reception of its first UL data by receiving a PDCCH addressing UE 402's C-RNTI in the target cell, which schedules a new transmission following the first UL data.

Although FIG. 4 illustrates one example procedure 400 for LTM, various changes may be made to FIG. 4. For example, while shown as a series of steps, various steps in FIG. 4 could overlap, occur in parallel, occur in a different order, occur any number of times, be omitted, or replaced by other steps.

Beam management is supported by wireless communication systems. In existing beam management procedures, the network may configure/activate frequent periodic or semi-persistent beam reporting (e.g., a number “N” best beams and corresponding layer one reference signal received powers [L1-RSRPs]) or trigger frequent aperiodic beam reporting to timely acquire the best/preferred beam for data/control transmissions. This results in large UL reporting overhead and control signaling overhead. However, if less frequent beam reporting is configured, the network may not always acquire the ‘best/preferred’ beam(s), as the beam reporting by the UE may be outdated, thus leading to performance degradation. Given that the UE has better and more-timely knowledge of beam quality changes, UE-initiated beam reporting procedures can lead to more timely beam reports with reduced reporting overhead. Under such a procedure, if the UE determines that e.g., current beam(s) quality becomes poor, the UE can trigger beam reporting without the network configuring or triggering frequent reporting.

Two approaches for UE-initiated/event triggered beam reporting are referred to herein as “approach one” and “approach two.” In approach one (which may also be referred to as “Mode A”), the UE first transmits on a first PUCCH channel to request a resource for transmitting a beam report on a second UL channel (e.g., a PUSCH). The UE receives a grant from the gNB for the second UL channel. The UE then transmits a beam report in the received UL grant. In approach two (which may also be referred to as “Mode B”), the UE transmits on first a PUCCH channel notifying the gNB that the UE will be transmitting a beam report in a second UL channel (e.g., a PUSCH). The resources for the second UL channel are pre-configured.

An issue with UE-initiated/event triggered beam reporting is how the UE determines whether to use approach one or approach two when performing a UE-initiated/event triggered beam reporting, as there can be several PUCCH resources configured for an SpCell and/or PUCCH SCell. Various embodiments of the present disclosure provide mechanisms for a UE to determine which PUCCH resource to select for UE-initiated/event triggered beam reporting.

In some wireless networks, L1 measurement RSs (i.e., SSBs) configuration of candidate LTM cells are signaled to the UE. The UE measures these RSs transmitted by the candidate LTM cells and transmits L1 measurement report(s) of the candidate LTM cell(s) to the source cell/gNB. The L1 measurement report(s) report/include beam measurements (i.e., L1-RSRP) of candidate LTM cells. After an LTM cell switch is completed, CSI may be computed and a CSI report may be transmitted to the switched cell. For the network to select the modulation coding scheme (MCS) and other scheduling parameters as soon as possible, CSI (Channel Quality Information [CQI] and/or Precoding Matrix Indicator [PMI] and Layer Indicator [LI] and/or Rank Indicator [RI]) can be computed and reported as soon as possible (e.g., before or during the LTM cell switch).

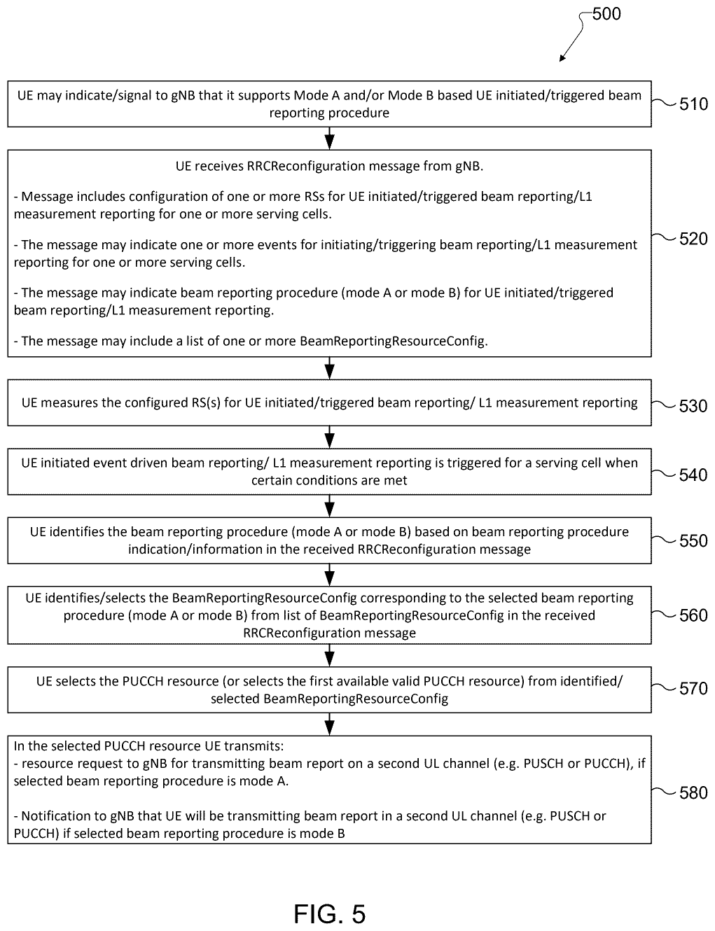

FIG. 5 illustrates an example procedure 500 for UE initiated/event triggered beam reporting according to embodiments of the present disclosure. An embodiment of the procedure illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of a procedure for UE initiated/event triggered beam reporting could be used without departing from the scope of this disclosure.

In the example of FIG. 5, procedure 500 begins at operation 510.

In some embodiments, at operation 510, a UE (such as UE 116 of FIG. 1), which may be in an RRC_CONNECTED state, may indicate/signal to a gNB (such as gNB 102 of FIG. 1) that the UE supports UE initiated/triggered beam reporting (or UE initiated/triggered L1 measurement reporting). In some embodiments, the UE may indicate/signal to the gNB that the UE supports Mode A based UE initiated/triggered beam reporting procedure (or UE initiated/triggered L1 measurement reporting procedure). In some embodiments, the UE may indicate/signal to the gNB that the UE supports Mode B based UE initiated/triggered beam reporting procedure (or UE initiated/triggered L1 measurement reporting procedure).

In some embodiments, at operation 510, the UE may indicate/signal to the gNB that the UE supports UE initiated/triggered beam reporting procedure (or UE initiated/triggered L1 measurement reporting procedure). In these embodiments, the UE mandatorily supports Mode A if the UE supports UE initiated beam reporting (or UE initiated/triggered L1 measurement reporting). Mode B can be optional based on UE capability. The UE may indicate/signal to the gNB whether the UE supports Mode B based UE initiated/triggered beam reporting procedure (or UE initiated/triggered L1 measurement reporting procedure).

In some embodiments, at operation 510, the UE may indicate/signal to the gNB that the UE supports UE initiated/triggered beam reporting procedure (or UE initiated/triggered L1 measurement reporting procedure). In these embodiments, the UE mandatorily supports Mode B if the UE supports UE initiated beam reporting (or UE initiated/triggered L1 measurement reporting). Mode A can be optional based on UE capability. The UE may indicate/signal to the gNB whether the UE supports Mode A based UE initiated/triggered beam reporting procedure (or UE initiated/triggered L1 measurement reporting procedure).

In some embodiments, the UE capabilities indicated/signaled at operation 510 may be signaled per UE (which means that the UE supports or does not support the capabilities irrespective of any frequency band). Alternately, in some embodiments, these capabilities may be signaled per frequency band (or per FR1, FR2-1, FR2-2, FR2-NTN, etc.), wherein the UE may support the capabilities for some frequency bands, all of the frequency bands, or none of the frequency bands. For example, FR1 can be a frequency range from 410 MHz-7125 MHz, FR2-1 can be a frequency range from 24250 MHz-52600 MHZ, FR2-2 can be a frequency range from 52600 MHZ-71000 MHz, FR2-NTN can be a frequency range from 17300 MHz-30000 MHZ, etc. Alternately, in some embodiments, these capabilities may be signaled per frequency band combination. Alternately, in some embodiments, these capabilities may be signaled per band per band combination. Alternately, in some embodiments, these capabilities may be signaled per component carrier per band per band combination (feature set per component carrier). In some embodiments, these capabilities may be signaled by the UE to the gNB via an RRC message (e.g., a UE capability information message, RRC Resume Complete message, RRC connection setup complete message or any new message). In some embodiments, these capabilities may be signaled by the UE to the gNB upon receiving a request from the gNB. In some embodiments, these capabilities may be signaled by the UE to the gNB upon entering the RRC_CONNECTED state. In some embodiments, these capabilities may be signaled by UE to the gNB when the UE is configured with a serving cell with multiple beams (or RSs QCLed with beams/SSBs).

At operation 520, the UE receives an RRCReconfiguration message from the gNB. The message includes a configuration of one or more RSs for UE initiated/triggered beam reporting (or UE initiated/triggered L1 measurement reporting) for one or more serving cells.

In some embodiments, the message may indicate one or more events for initiating/triggering beam reporting (or UE initiated/triggered L1 measurement reporting) for one or more serving cells.

In some embodiments, the message may indicate a beam reporting procedure (Mode A or Mode B) for UE initiated/triggered beam reporting. This indication can be per event or per L1 measurement configuration or per serving cell or per cell group or per BWP (i.e., per BWP per serving cell).

In some embodiments, the message may include a list of one or more BeamReportingResourceConfig. This configuration can be for a serving cell (e.g., SpCell or PUCCH SCell) configured with a PUCCH. In these embodiments, each BeamReportingResourceConfig incudes BeamReportingResourceId, periodicity AndOffset, PUCCH resource identified by PUCCH-ResourceId and beam reporting procedure type (Mode A or Mode B). The PUCCH resource identified by PUCCH-ResourceId occurs periodically starting at an offset from SFN 0, where the period and offset are signaled by periodicity AndOffset. In these embodiments, the message includes a list of PUCCH-Resource wherein each PUCCH-resource is identified by PUCCH-ResourceId. PUCCH-Resource includes PUCCH-ResourceId, startingPRB index and PUCCH format. PUCCH format can be zero/one. PUCCH-format0 includes initialCyclicShift, nrofSymbols and startingSymbolIndex. PUCCH-format0 includes initialCyclicShift, nrofSymbols, startingSymbolIndex and timeDomainOCC.

At operation 530, the UE performs the measurement (i.e., the UE measures L1-RSRPs/RSRQs/SINRs etc. as configured, of the configured RSs for UE initiated/triggered beam reporting/L1 measurement reporting).

At operation 540, when the UE initiated event driven beam reporting/L1 measurement reporting is triggered for a serving cell, the UE performs operations 550-580.

At operation 550, the UE identifies the beam reporting procedure (Mode A or Mode B) based on a beam reporting procedure indication/information in the received RRCReconfiguration message. If the beam reporting procedure (Mode A or Mode B) is indicated per event, the UE selects the beam reporting procedure (Mode A or Mode B) based on the beam reporting procedure indication/information for the event which triggered the beam reporting/L1 measurement reporting. If the beam reporting procedure (Mode A or Mode B) is indicated per L1 measurement configuration, the UE selects the beam reporting procedure (Mode A or Mode B) based on the beam reporting procedure indication/information for the L1 measurement configuration corresponding to the triggered beam reporting/L1 measurement reporting. If the beam reporting procedure (Mode A or Mode B) is indicated per serving cell, the UE selects the beam reporting procedure (Mode A or Mode B) based on the beam reporting procedure indication/information of the serving cell associated with triggered beam reporting/L1 measurement reporting. If the beam reporting procedure (Mode A or Mode B) is indicated per cell group, the UE selects the beam reporting procedure (Mode A or Mode B) based on the beam reporting procedure indication/information of the cell group of the serving cell associated with triggered beam reporting/L1 measurement reporting.

At operation 560, the UE identifies/selects the BeamReportingResourceConfig corresponding to the selected beam reporting procedure (Mode A or Mode B) from a list of BeamReportingResourceConfig in the received RRCReconfiguration message.

At operation 570, the UE selects a PUCCH resource (or selects the first available valid PUCCH resource) from the identified/selected BeamReportingResourceConfig (or selects the PUCCH resource based on the PUCCH resource configuration in the identified/selected BeamReportingResourceConfig)

At operation 580, based on the selected beam reporting procedure, the UE transmits one of the following in the selected PUCCH resource:
A resource request to the gNB for transmitting a beam report on a second UL channel (e.g., PUSCH or PUCCH), if the selected beam reporting procedure is Mode A.
A notification to the gNB that the UE will be transmitting a beam report in a second UL channel (e.g., PUSCH or PUCCH) if the selected beam reporting procedure is Mode B.

In some embodiments, if the list of one or more BeamReportingResourceConfig is configured for multiple serving cells with a PUCCH, the network can indicate for which event a report is sent on the PUCCH of which serving cell. In these embodiments, the UE accordingly determines a BeamReportingResourceConfig and transmits the PUCCH.

In some embodiments, for UE initiated beam reporting for a serving cell, the network can indicate the serving cell (serving cell with a PUCCH [e.g., SpCell or PUCCH SCell]) to which the UE should transmit the PUCCH (the UE may select a BeamReportingResourceConfig of the serving cell to which the UE transmits the PUCCH) for beam reporting.

In some embodiments, a list of PUCCH resources may be signaled by the gNB in an RRCReconfiguration message. In each PUCCH resource configuration, the gNB may indicate whether the PUCCH resource can be used for UE initiated/triggered beam reporting/L1 measurement reporting. In each PUCCH resource configuration, the gNB may indicate whether the PUCCH resource can be used for Mode A or Mode B based UE initiated/triggered beam reporting/L1 measurement reporting procedure. The UE accordingly can select the PUCCH resource corresponding to the selected beam reporting procedure.

Although FIG. 5 illustrates one example procedure 500 for UE initiated/event triggered beam reporting, various changes may be made to FIG. 5. For example, while shown as a series of operations, various operations in FIG. 5 could overlap, occur in parallel, occur in a different order, occur any number of times, be omitted, or replaced by other operations.

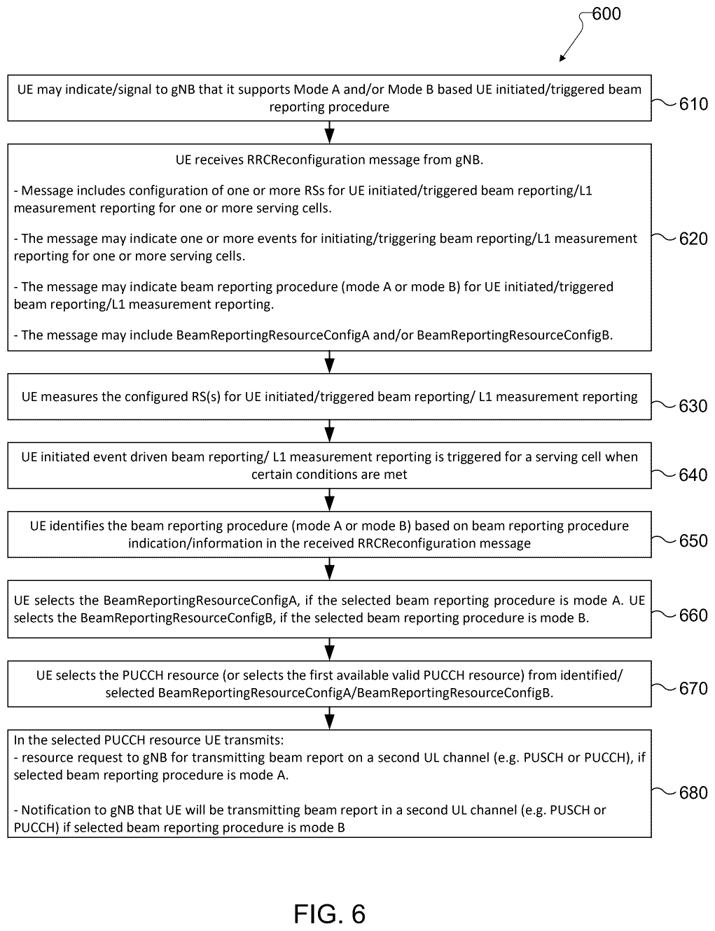

FIG. 6 illustrates another example procedure 600 for UE initiated/event triggered beam reporting according to embodiments of the present disclosure. An embodiment of the procedure illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of a procedure for UE initiated/event triggered beam reporting could be used without departing from the scope of this disclosure.

In the example of FIG. 6, procedure 600 begins at operation 610.

In some embodiments, at operation 610, a UE (such as UE 116 of FIG. 1), which may be in an RRC_CONNECTED state, may indicate/signal to a gNB (such as gNB 102 of FIG. 1) that the UE supports UE initiated/triggered beam reporting (or UE initiated/triggered L1 measurement reporting). In some embodiments, the UE may indicate/signal to the gNB that the UE supports Mode A based UE initiated/triggered beam reporting procedure (or UE initiated/triggered L1 measurement reporting procedure). In some embodiments, the UE may indicate/signal to the gNB that the UE supports Mode B based UE initiated/triggered beam reporting procedure (or UE initiated/triggered L1 measurement reporting procedure).

In some embodiments, at operation 610, the UE may indicate/signal to the gNB that the UE supports UE initiated/triggered beam reporting procedure (or UE initiated/triggered L1 measurement reporting procedure). In these embodiments, the UE mandatorily supports Mode A if the UE supports UE initiated beam reporting (or UE initiated/triggered L1 measurement reporting). Mode B can be optional based on UE capability. The UE may indicate/signal to the gNB whether the UE supports Mode B based UE initiated/triggered beam reporting procedure (or UE initiated/triggered L1 measurement reporting procedure).

In some embodiments, at operation 610, the UE may indicate/signal to the gNB that the UE supports UE initiated/triggered beam reporting procedure (or UE initiated/triggered L1 measurement reporting procedure). In these embodiments, the UE mandatorily supports Mode B if the UE supports UE initiated beam reporting (or UE initiated/triggered L1 measurement reporting). Mode A can be optional based on UE capability. The UE may indicate/signal to the gNB whether the UE supports Mode A based UE initiated/triggered beam reporting procedure (or UE initiated/triggered L1 measurement reporting procedure).

In some embodiments, the UE capabilities indicated/signaled at operation 610 may be signaled per UE (which means that UE supports or does not support the capabilities irrespective of any frequency band). Alternately, in some embodiments, these capabilities may be signaled per frequency band (or per FR1, FR2-1, FR2-2, FR2-NTN, etc.), wherein the UE may support the capabilities for some frequency bands, all of the frequency bands, or none of the frequency bands. For example, FR1 can be a frequency range from 410 MHz-7125 MHz, FR2-1 can be a frequency range from 24250 MHz-52600 MHZ, FR2-2 can be a frequency range from 52600 MHZ-71000 MHz, FR2-NTN can be a frequency range from 17300 MHz-30000 MHZ, etc. Alternately, in some embodiments, these capabilities may be signaled per frequency band combination. Alternately, in some embodiments, these capabilities may be signaled per band per band combination. Alternately, in some embodiments, these capabilities may be signaled per component carrier per band per band combination (feature set per component carrier). In some embodiments, these capabilities may be signaled by the UE to the gNB via an RRC message (e.g., a UE capability information message, RRC Resume Complete message, RRC connection setup complete message or any new message). In some embodiments, these capabilities may be signaled by the UE to the gNB upon receiving a request from the gNB. In some embodiments, these capabilities may be signaled by the UE to the gNB upon entering an RRC_CONNECTED state. In some embodiments, these capabilities may be signaled by the UE to the gNB when the UE is configured with a serving cell with multiple beams (or RSs QCLed with beams/SSBs).

At operation 620, the UE receives an RRCReconfiguration message from the gNB. The message includes configuration of one or more RSs for UE initiated/triggered beam reporting (or UE initiated/triggered L1 measurement reporting) for one or more serving cells.

In some embodiments, the message may indicate one or more events for initiating/triggering beam reporting (or UE initiated/triggered L1 measurement reporting) for one or more serving cells.

In some embodiments, the message may indicate a beam reporting procedure (Mode A or Mode B) for UE initiated/triggered beam reporting. This indication can be per event or per L1 measurement configuration or per serving cell or per cell group or per BWP.

In some embodiments, the message may include BeamReportingResourceConfigA and/or BeamReportingResourceConfigB. In these embodiments, BeamReportingResourceConfigA and BeamReportingResourceConfigB include periodicity AndOffset, and a PUCCH resource identified by PUCCH-ResourceId. The PUCCH resource identified by PUCCH-ResourceId occurs periodically starting at an offset from SFN 0, where the period and offset are signaled by periodicity AndOffset. In these embodiments, the message includes a list of PUCCH-Resource wherein each PUCCH-resource is identified by PUCCH-ResourceId. PUCCH-Resource includes PUCCH-ResourceId, startingPRB index and PUCCH format. The PUCCH format can be zero/one. PUCCH-format0 includes initialCyclicShift, nrofSymbols and startingSymbolIndex. PUCCH-format0 includes initialCyclicShift, nrofSymbols, startingSymbolIndex and timeDomainOCC.

At operation 630, the UE performs the measurement (i.e., the UE measures L1-RSRPs/RSRQs/SINRs etc. as configured, of the configured RSs for UE initiated/triggered beam reporting/L1 measurement reporting).

At operation 640, When the UE initiated event driven beam reporting/L1 measurement reporting is triggered for a serving cell, the UE performs operations 650-680.

At operation 650, the UE identifies the beam reporting procedure (Mode A or Mode B) based on a beam reporting procedure indication/information in the received RRCReconfiguration message. If the beam reporting procedure (Mode A or Mode B) is indicated per event, the UE selects the beam reporting procedure (Mode A or Mode B) based on the beam reporting procedure indication/information for the event which triggered beam reporting/L1 measurement reporting. If the beam reporting procedure (Mode A or Mode B) is indicated per L1 measurement configuration, the UE selects the beam reporting procedure (Mode A or Mode B) based on the beam reporting procedure indication/information for the L1 measurement configuration corresponding to the triggered beam reporting/L1 measurement reporting. If the beam reporting procedure (Mode A or Mode B) is indicated per serving cell, the UE selects the beam reporting procedure (Mode A or Mode B) based on the beam reporting procedure indication/information of the serving cell associated with triggered beam reporting/L1 measurement reporting. If the beam reporting procedure (Mode A or Mode B) is indicated per cell group, the UE selects the beam reporting procedure (Mode A or Mode B) based on the beam reporting procedure indication/information of the cell group of the serving cell associated with triggered beam reporting/L1 measurement reporting.

At operation 660, the UE selects the BeamReportingResourceConfigA, if the selected beam reporting procedure is Mode A. The UE selects the BeamReportingResourceConfigB, if the selected beam reporting procedure is Mode B.

At operation 670, the UE selects a PUCCH resource (or selects the first available valid PUCCH resource) from the selected BeamReportingResourceConfigA/BeamReportingResourceConfigB (or selects the PUCCH resource based on a PUCCH resource configuration in the identified/selected BeamReportingResourceConfigA/BeamReportingResourceConfigB).

At operation 680, based on the selected beam reporting procedure, the UE transmits one of the following in the selected PUCCH resource:
A resource request to the gNB for transmitting a beam report on a second UL channel (e.g., PUSCH or PUCCH), if the selected beam reporting procedure is Mode A.
A notification to the gNB that the UE will be transmitting a beam report in a second UL channel (e.g., PUSCH or PUCCH) if the selected beam reporting procedure is Mode B.

In some embodiments, if BeamReportingResourceConfigA/BeamReportingResourceConfigB is configured for multiple serving cells with a PUCCH, the network can indicate for which event a report is sent on the PUCCH of which serving cell. In these embodiments, the UE accordingly determines BeamReportingResourceConfigA/BeamReportingResourceConfigB and transmits the PUCCH.

In some embodiments, for UE initiated beam reporting for a serving cell, the network can indicate the serving cell (serving cell with a PUCCH [e.g., SpCell or PUCCH SCell]) to which the UE should transmit the PUCCH (the UE may select BeamReportingResourceConfigA/BeamReportingResourceConfigB of the serving cell to which the UE transmits the PUCCH) for beam reporting.

In some embodiments, instead of BeamReportingResourceConfig, a list of SchedulingRequestResourceConfig may be signaled by the gNB in a RRCReconfiguration message. Each SchedulingRequestResourceConfig is identified by a SchedulingRequestResourceId. SchedulingRequestResourceConfig includes periodicity AndOffset, and a PUCCH resource identified by PUCCH-ResourceId. The PUCCH resource identified by PUCCH-ResourceId occurs periodically starting at an offset from SFN 0, where the period and offset are signaled by periodicityAndOffset. The Network can indicate SchedulingRequestResourceId for Mode A based UE initiated beam reporting and indicate SchedulingRequestResourceId for Mode B based UE initiated beam reporting. The indication can be per BWP/per serving cell/per cell group. The UE selects a SchedulingRequestResourceConfig corresponding to a SchedulingRequestResourceId for the identified UE initiated beam reporting procedure. The UE selects the PUCCH resource (or selects the first available valid PUCCH resource) from SchedulingRequestResourceConfig (or selects the PUCCH resource based on a PUCCH resource configuration in SchedulingRequestResourceConfig) and transmits one of the following in the selected PUCCH resource:
A resource request to the gNB for transmitting a beam report on a second UL channel (e.g., a PUSCH or PUCCH), if the identified beam reporting procedure is Mode A.
A Notification to the gNB that the UE will be transmitting a beam report in a second UL channel (e.g., PUSCH or PUCCH) if the identified beam reporting procedure is Mode B.

Although FIG. 6 illustrates one example procedure 600 for UE initiated/event triggered beam reporting, various changes may be made to FIG. 6. For example, while shown as a series of operations, various operations in FIG. 6 could overlap, occur in parallel, occur in a different order, occur any number of times, be omitted, or replaced by other operations.

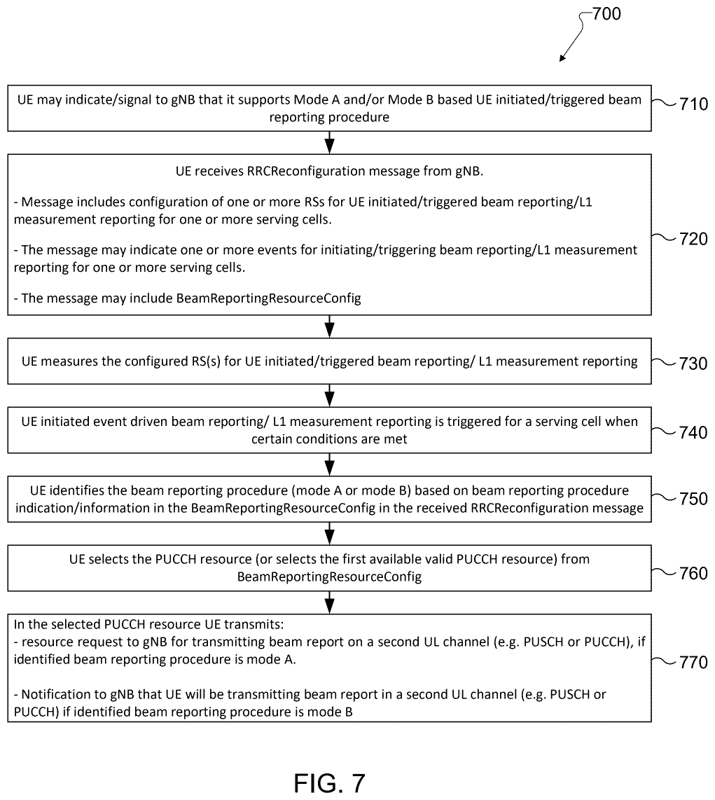

FIG. 7 illustrates another example procedure 700 for UE initiated/event triggered beam reporting according to embodiments of the present disclosure. An embodiment of the procedure illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of a procedure for UE initiated/event triggered beam reporting could be used without departing from the scope of this disclosure.

In the example of FIG. 7, procedure 700 begins at operation 710.

In some embodiments, at operation 710, a UE (such as UE 116 of FIG. 1), which may be in an RRC_CONNECTED state, may indicate/signal to a gNB (such as gNB 102 of FIG. 1) that the UE supports UE initiated/triggered beam reporting (or UE initiated/triggered L1 measurement reporting). In some embodiments, the UE may indicate/signal to the gNB that the UE supports Mode A based UE initiated/triggered beam reporting procedure (or UE initiated/triggered L1 measurement reporting procedure). In some embodiments, the UE may indicate/signal to the gNB that the UE supports Mode B based UE initiated/triggered beam reporting procedure (or UE initiated/triggered L1 measurement reporting procedure).

In some embodiments, at operation 710, the UE may indicate/signal to the gNB that the UE supports UE initiated/triggered beam reporting procedure (or UE initiated/triggered L1 measurement reporting procedure). In these embodiments, the UE mandatorily supports Mode A if the UE supports UE initiated beam reporting (or UE initiated/triggered L1 measurement reporting). Mode B can be optional based on UE capability. The UE may indicate/signal to the gNB whether the UE supports Mode B based UE initiated/triggered beam reporting procedure (or UE initiated/triggered L1 measurement reporting procedure).

In some embodiments, at operation 710, the UE may indicate/signal to the gNB that the UE supports UE initiated/triggered beam reporting procedure (or UE initiated/triggered L1 measurement reporting procedure). In these embodiments, the UE mandatorily supports Mode B if the UE supports UE initiated beam reporting (or UE initiated/triggered L1 measurement reporting). Mode A can be optional based on UE capability. The UE may indicate/signal to the gNB whether the UE supports Mode A based UE initiated/triggered beam reporting procedure (or UE initiated/triggered L1 measurement reporting procedure).

In some embodiments, the UE capabilities indicated/signaled at operation 710 may be signaled per UE (which means that UE supports or does not support the capabilities irrespective of any frequency band). Alternately, in some embodiments, these capabilities may be signaled per frequency band (or per FR1, FR2-1, FR2-2, FR2-NTN, etc.), wherein the UE may support the capabilities for some frequency bands, all of the frequency bands, or none of the frequency bands. For example, FR1 can be a frequency range from 410 MHz-7125 MHz, FR2-1 can be a frequency range from 24250 MHz-52600 MHZ, FR2-2 can be a frequency range from 52600 MHz-71000 MHz, FR2-NTN can be a frequency range from 17300 MHz-30000 MHZ, etc. Alternately, in some embodiments, these capabilities may be signaled per frequency band combination. Alternately, in some embodiments, these capabilities may be signaled per band per band combination. Alternately, in some embodiments, these capabilities may be signaled per component carrier per band per band combination (feature set per component carrier). In some embodiments, these capabilities may be signaled by the UE to the gNB via an RRC message (e.g., a UE capability information message, RRC Resume Complete message, RRC connection setup complete message or any new message). In some embodiments, these capabilities may be signaled by the UE to the gNB upon receiving a request from the gNB. In some embodiments, these capabilities may be signaled by the UE to the gNB upon entering an RRC_CONNECTED state. In some embodiments, these capabilities may be signaled by the UE to the gNB when the UE is configured with a serving cell with multiple beams (or RSs QCLed with beams/SSBs).

At operation 720, the UE receives an RRCReconfiguration message from the gNB. The message includes configuration of one or more RSs for UE initiated/triggered beam reporting (or UE initiated/triggered L1 measurement reporting) for one or more serving cells.

In some embodiments, the message may indicate one or more events for initiating/triggering beam reporting (or UE initiated/triggered L1 measurement reporting) for one or more serving cells.

In some embodiments, the message may include BeamReportingResourceConfig. 1n these embodiments, BeamReportingResourceConfig includes periodicity AndOffset, a PUCCH resource identified by PUCCH-ResourceId, and a beam reporting procedure type (Mode A or Mode B). The PUCCH resource identified by PUCCH-ResourceId occurs periodically starting at an offset from SFN 0, where the period and offset are signaled by periodicity AndOffset. In these embodiments, the message includes a list of PUCCH-Resource wherein each PUCCH-resource is identified by PUCCH-ResourceId. PUCCH-Resource includes PUCCH-ResourceId, startingPRB index and PUCCH format. PUCCH format can zero/one. PUCCH-format0 includes initialCyclicShift, nrofSymbols and starting SymbolIndex. PUCCH-format0 includes initialCyclicShift, nrofSymbols, startingSymbolIndex and timeDomainOCC.

At operation 730, the UE performs the measurement (i.e., the UE measures L1-RSRPs/RSRQs/SINRs etc. as configured, of the configured RSs for UE initiated/triggered beam reporting/L1 measurement reporting).

At operation 740, when the UE initiated event driven beam reporting/L1 measurement reporting is triggered for a serving cell, the UE performs operations 750-770.

At operation 750, the UE identifies the beam reporting procedure (Mode A or Mode B) based on a beam reporting procedure indication/information in the BeamReportingResourceConfig in the received RRCReconfiguration message.

At operation 760, the UE selects a PUCCH resource (or selects the first available valid PUCCH resource) from BeamReportingResourceConfig (or selects the PUCCH resource based on a PUCCH resource configuration in BeamReportingResourceConfig).

At operation 770, based on the identified beam reporting procedure, the UE transmits one of the following in the selected PUCCH resource:
A resource request to the gNB for transmitting a beam report on a second UL channel (e.g., PUSCH or PUCCH), if the identified beam reporting procedure is Mode A.
A Notification to the gNB that the UE will be transmitting a beam report in a second UL channel (e.g., PUSCH or PUCCH) if the identified beam reporting procedure is Mode B.

In some embodiments, if BeamReportingResourceConfig is configured for multiple serving cells with a PUCCH, the network can indicate for which event a report is sent on the PUCCH of which serving cell. In these embodiments, the UE accordingly determines a BeamReportingResourceConfig and transmits the PUCCH.

In some embodiments, for UE initiated beam reporting for a serving cell, the network can indicate the serving cell (serving cell with a PUCCH [e.g., SpCell or PUCCH SCell]) to which the UE should transmit the PUCCH (the UE may select a BeamReportingResourceConfig of the serving cell to which the UE transmits the PUCCH) for beam reporting.

In some embodiments, instead of BeamReportingResourceConfig, a list of SchedulingRequestResourceConfig may be signaled by the gNB in a RRCReconfiguration message. Each SchedulingRequestResourceConfig is identified by a SchedulingRequestResourceId. A SchedulingRequestResourceConfig includes periodicity AndOffset, and a PUCCH resource identified by PUCCH-ResourceId. The PUCCH resource identified by PUCCH-ResourceId occurs periodically starting at an offset from SFN 0, where the period and offset are signaled by periodicityAndOffset. The Network can indicate a SchedulingRequestResourceId for Mode A based UE initiated beam reporting and indicate a SchedulingRequestResourceId for Mode B based UE initiated beam reporting. The indication can be per BWP/per serving cell/per cell group. The UE selects a SchedulingRequestResourceConfig corresponding to a SchedulingRequestResourceId for the identified UE initiated beam reporting procedure. The UE selects a PUCCH resource (or selects the first available valid PUCCH resource) from SchedulingRequestResourceConfig (or selects the PUCCH resource based on a PUCCH resource configuration in SchedulingRequestResourceConfig) and transmits one of the following in the selected PUCCH resource:
A resource request to the gNB for transmitting a beam report on a second UL channel (e.g., a PUSCH or PUCCH), if the identified beam reporting procedure is Mode A.
A Notification to the gNB that the UE will be transmitting a beam report in a second UL channel (e.g., PUSCH or PUCCH) if the identified beam reporting procedure is Mode B.

In some embodiments, a list of PUCCH resources may be signaled by the gNB in a RRCReconfiguration message. In each PUCCH resource configuration, the gNB may indicate whether the PUCCH resource can be used for UE initiated/triggered beam reporting/L1 measurement reporting. In each PUCCH resource configuration the gNB may indicate whether the PUCCH resource can be used for Mode A or Mode B based UE initiated/triggered beam reporting/L1 measurement reporting procedure. The UE accordingly can select the PUCCH resource and beam reporting procedure based on the indication (e.g., if Mode A is indicated, the UE selects Mode A beam reporting procedure; if Mode B is indicated, the UE selects Mode B beam reporting procedure). The UE selects a PUCCH resource for which UE initiated/triggered beam reporting/L1 measurement reporting or UE initiated/triggered beam reporting/L1 measurement reporting procedure is indicated.

Although FIG. 7 illustrates one example procedure 700 for UE initiated/event triggered beam reporting, various changes may be made to FIG. 7. For example, while shown as a series of operations, various operations in FIG. 7 could overlap, occur in parallel, occur in a different order, occur any number of times, be omitted, or replaced by other operations.

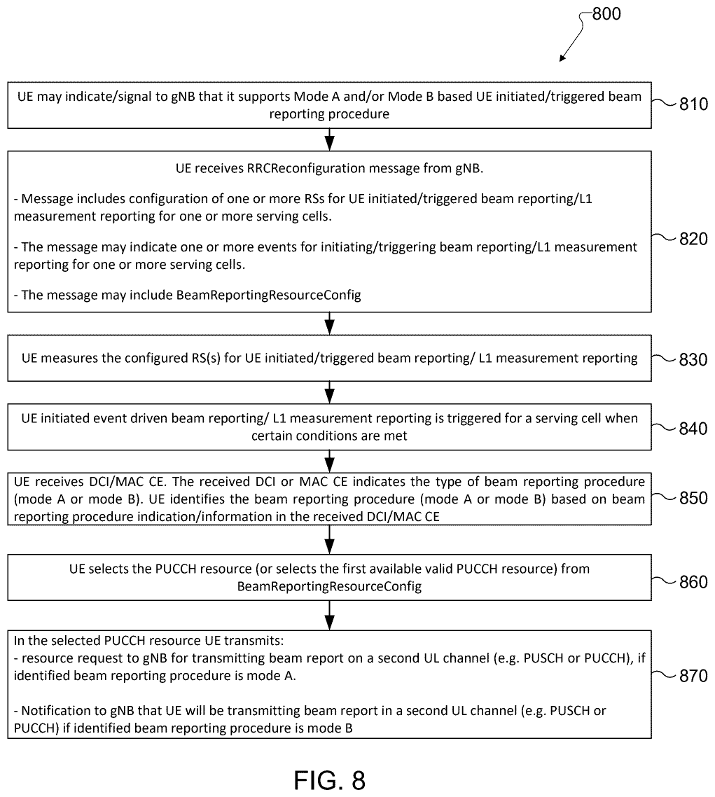

FIG. 8 illustrates another example procedure 800 for UE initiated/event triggered beam reporting according to embodiments of the present disclosure. An embodiment of the procedure illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of a procedure for UE initiated/event triggered beam reporting could be used without departing from the scope of this disclosure.

In the example of FIG. 8, procedure 800 begins at operation 810.

In some embodiments, at operation 810, a UE (such as UE 116 of FIG. 1), which may be in an RRC_CONNECTED state, may indicate/signal to a gNB (such as gNB 102 of FIG. 1) that the UE supports UE initiated/triggered beam reporting (or UE initiated/triggered L1 measurement reporting). In some embodiments, the UE may indicate/signal to the gNB that the UE supports Mode A based UE initiated/triggered beam reporting procedure (or UE initiated/triggered L1 measurement reporting procedure). In some embodiments, the UE may indicate/signal to the gNB that the UE supports Mode B based UE initiated/triggered beam reporting procedure (or UE initiated/triggered L1 measurement reporting procedure).

In some embodiments, at operation 810, the UE may indicate/signal to the gNB that the UE supports UE initiated/triggered beam reporting procedure (or UE initiated/triggered L1 measurement reporting procedure). In these embodiments, the UE mandatorily supports Mode A if the UE supports UE initiated beam reporting (or UE initiated/triggered L1 measurement reporting). Mode B can be optional based on UE capability. The UE may indicate/signal to the gNB whether the UE supports Mode B based UE initiated/triggered beam reporting procedure (or UE initiated/triggered L1 measurement reporting procedure).

In some embodiments, at operation 810, the UE may indicate/signal to the gNB that the UE supports UE initiated/triggered beam reporting procedure (or UE initiated/triggered L1 measurement reporting procedure). In these embodiments, the UE mandatorily supports Mode B if the UE supports UE initiated beam reporting (or UE initiated/triggered L1 measurement reporting). Mode A can be optional based on UE capability. The UE may indicate/signal to the gNB whether the UE supports Mode A based UE initiated/triggered beam reporting procedure (or UE initiated/triggered L1 measurement reporting procedure).

In some embodiments, the UE capabilities indicated/signaled at operation 810 may be signaled per UE (which means that UE supports or does not support the capabilities irrespective of any frequency band). Alternately, in some embodiments, these capabilities may be signaled per frequency band (or per FR1, FR2-1, FR2-2, FR2-NTN, etc.), wherein the UE may support the capabilities for some frequency bands, all of the frequency bands, or none of the frequency bands. For example, FR1 can be a frequency range from 410 MHz-7125 MHz, FR2-1 can be a frequency range from 24250 MHz-52600 MHz, FR2-2 can be a frequency range from 52600 MHZ-71000 MHz, FR2-NTN can be a frequency range from 17300 MHz-30000 MHz, etc. Alternately, in some embodiments, these capabilities may be signaled per frequency band combination. Alternately, in some embodiments, these capabilities may be signaled per band per band combination. Alternately, in some embodiments, these capabilities may be signaled per component carrier per band per band combination (feature set per component carrier). In some embodiments, these capabilities may be signaled by the UE to the gNB via an RRC message (e.g., a UE capability information message, RRC Resume Complete message, RRC connection setup complete message or any new message). In some embodiments, these capabilities may be signaled by the UE to the gNB upon receiving a request from the gNB. In some embodiments, these capabilities may be signaled by the UE to the gNB upon entering an RRC_CONNECTED state. In some embodiments, these capabilities may be signaled by the UE to the gNB when the UE is configured with a serving cell with multiple beams (or RSs QCLed with beams/SSBs).

At operation 820, the UE receives an RRCReconfiguration message from the gNB. The message includes configuration of one or more RSs for UE initiated/triggered beam reporting (or UE initiated/triggered L1 measurement reporting) for one or more serving cells.

In some embodiments, the message may indicate one or more events for initiating/triggering beam reporting (or UE initiated/triggered L1 measurement reporting) for one or more serving cells.

In some embodiments, the message may include BeamReportingResourceConfig. In these embodiments, BeamReportingResourceConfig includes periodicityAndOffset, and a PUCCH resource identified by PUCCH-ResourceId. The PUCCH resource identified by PUCCH-ResourceId occurs periodically starting at an offset from SFN 0, where the period and offset are signaled by periodicity AndOffset. In these embodiments, the message includes a list of PUCCH-Resource, wherein each PUCCH-resource is identified by PUCCH-ResourceId. PUCCH-Resource includes PUCCH-ResourceId, startingPRB index and PUCCH format. PUCCH format can be zero/one. PUCCH-format0 includes initialCyclicShift, nrofSymbols and startingSymbolIndex. PUCCH-format0 includes initialCyclicShift, nrofSymbols, startingSymbolIndex and timeDomainOCC.

At operation 830, the UE performs the measurement (i.e., the UE measures L1-RSRPs/RSRQs/SINRs etc. as configured, of the configured RSs for UE initiated/triggered beam reporting/L1 measurement reporting).

At operation 840, when the UE initiated event driven beam reporting/L1 measurement reporting is triggered for a serving cell, the UE performs operations 850-870.

At operation 850, the UE receives a DCI or MAC CE from the gNB. The received DCI or MAC CE indicates the type of beam reporting procedure (Mode A or Mode B). The UE identifies the beam reporting procedure (Mode A or Mode B) based on a beam reporting procedure indication/information in the received DCI/MAC CE.

At operation 860, the UE selects a PUCCH resource (or selects the first available valid PUCCH resource) from BeamReportingResourceConfig (or selects the PUCCH resource based on a PUCCH resource configuration in BeamReportingResourceConfig).

At operation 870, based on the identified beam reporting procedure, the UE transmits one of the following in the selected PUCCH resource:
A resource request to the gNB for transmitting a beam report on a second UL channel (e.g., PUSCH or PUCCH), if the identified beam reporting procedure is Mode A.
A notification to the gNB that the UE will be transmitting a beam report in a second UL channel (e.g., PUSCH or PUCCH) if the identified beam reporting procedure is Mode B.

In some embodiments, if BeamReportingResourceConfig is configured for multiple serving cells with a PUCCH, the network can indicate for which event a report is sent on the PUCCH of which serving cell. In these embodiments, the UE accordingly determines a BeamReportingResourceConfig and transmits the PUCCH.

In some embodiments, for UE initiated beam reporting for a serving cell, the network can indicate the serving cell (serving cell with a PUCCH [e.g., SpCell or PUCCH SCell]) to which the UE should transmit the PUCCH (the UE may select a BeamReportingResourceConfig of the serving cell to which the UE transmits the PUCCH) for beam reporting.

In some embodiments, instead of BeamReportingResourceConfig, a list of SchedulingRequestResourceConfig may be signaled by the gNB in a RRCReconfiguration message. Each SchedulingRequestResourceConfig is identified by a SchedulingRequestResourceId. SchedulingRequestResourceConfig includes periodicity AndOffset, and a PUCCH resource identified by PUCCH-ResourceId. The PUCCH resource identified by PUCCH-ResourceId occurs periodically starting at an offset from SFN 0, where the period and offset are signaled by periodicityAndOffset. The Network can indicate SchedulingRequestResourceId for Mode A based UE initiated beam reporting and indicate SchedulingRequestResourceId for Mode B based UE initiated beam reporting. The indication can be per BWP/per serving cell/per cell group. The UE selects a SchedulingRequestResourceConfig corresponding to a SchedulingRequestResourceId for the identified UE initiated beam reporting procedure. The UE selects the PUCCH resource (or selects the first available valid PUCCH resource) from SchedulingRequestResourceConfig (or selects the PUCCH resource based on a PUCCH resource configuration in SchedulingRequestResourceConfig) and transmits one of the following in the selected PUCCH resource:
A resource request to the gNB for transmitting a beam report on a second UL channel (e.g., a PUSCH or PUCCH), if the identified beam reporting procedure is Mode A.
A Notification to the gNB that the UE will be transmitting a beam report in a second UL channel (e.g., PUSCH or PUCCH) if the identified beam reporting procedure is Mode B.

In some embodiments, an indication of Mode A or Mode B beam reporting procedure is configured per BWP, and any SR/PUCCH resource configured for the UE on the BWP can be used for the indicated mode (i.e., there is no dedicated SR/PUCCH resource).

In some embodiments, a list of SchedulingRequestIds or PUCCH-ResourceSetIds or PUCCH-ResourceIds can be marked by a flag/indication of either Mode A or Mode B.

Although FIG. 8 illustrates one example procedure 800 for UE initiated/event triggered beam reporting, various changes may be made to FIG. 8. For example, while shown as a series of operations, various operations in FIG. 8 could overlap, occur in parallel, occur in a different order, occur any number of times, be omitted, or replaced by other operations.

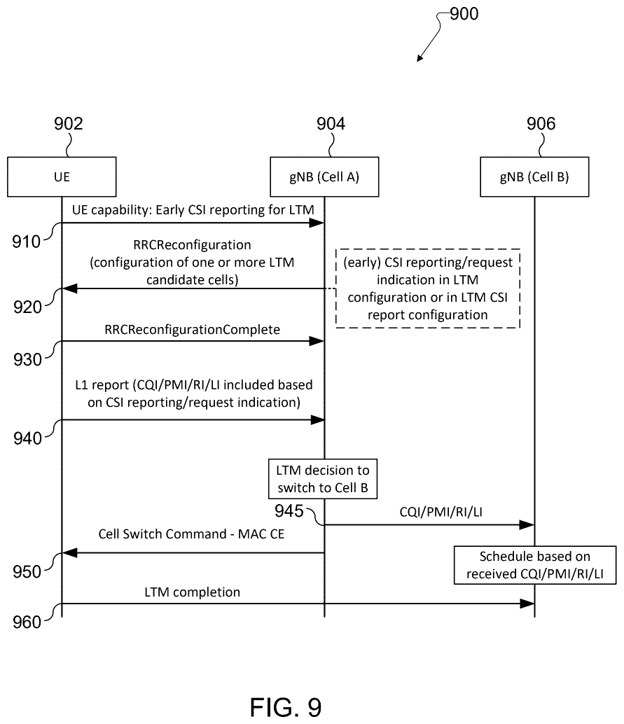

FIG. 9 illustrates an example procedure 900 for CSI reporting/acquisition during a lower layer triggered mobility procedure. An embodiment of the procedure illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of a procedure for UE initiated/event triggered beam reporting could be used without departing from the scope of this disclosure.

In the example of FIG. 9, procedure 900 begins at operation 910. At operation 910, a UE 902 may indicate a UE capability that UE 902 supports CSI reporting (or early CSI reporting/acquisition) for LTM candidate cell(s) to gNB 904 of the serving cell (e.g., Cell A). The UE capability can be indicated per FR (e.g., FR1. FR2-1, FR2-2, FR3, etc.) or per UE or per band or per duplex mode (FDD/TDD) or per band combination. This UE capability can be signaled in a UE capability information message or any other RRC message.

At operation 920, UE 902 receives an RRCReconfiguration message from gNB 904 of the serving cell (e.g., Cell A). The received RRCReconfiguration message includes an LTM configuration. The LTM configuration may include a configuration of one or more LTM candidate cells (e.g., Cell B, Cell C etc.). The configuration of each LTM candidate cell can be a RRCReconfiguration IE. The configuration of each LTM candidate cell is identified by an LTM candidate configuration ID. The LTM configuration includes a configuration of LTM CSI resource configurations for L1 measurements based on SSBs, where each LTM CSI resource configuration includes a ltm-CandidateIdList and ltm-CSI-SSB-ResourceList. Each LTM CSI resource configuration is identified by an LTM CSI resource configuration ID. ltm-CandidateIdList indicates the LTM candidate configuration IDs related to the SSBs in the ltm-CSI-SSB-ResourceList. Each entry in the ltm-CandidateIdList is a LTM candidate configuration ID. The list has the same number of entries as ltm-CSI-SSB-ResourceList. The first entry in this list shall be associated to the first entry in ltm-CSI-SSB-ResourceList, the second entry of this list shall be associated to the second entry in ltm-CSI-SSB-ResourceList, and so on. ltm-CSI-SSB-ResourceList is used to indicate SS/PBCH block resources from one or more LTM candidate cells. Each entry in ltm-CSI-SSB-ResourceList is an SSB index.

In some embodiments, the LTM configuration includes a configuration of LTM CSI resource configurations for L1 measurements based on CSI-RSs. In these embodiments, Each LTM CSI resource configuration is identified by an LTM CSI resource configuration ID. Each LTM CSI resource configuration may include a ltm-CandidateIdList and ltm-CSI-SSB-ResourceList. ltm-CandidateIdList indicates the LTM candidate configuration IDs related to the CSI-RSs in the ltm-CSI-SSB-ResourceList. Each entry in ltm-CandidateIdList is an LTM candidate configuration ID. The first entry in this list shall be associated to the first entry in ltm-CSI-SSB-ResourceList, the second entry of this list shall be associated to the second entry in ltm-CSI-SSB-ResourceList, and so on. ltm-CSI-SSB-ResourceList is used to indicate CSI RS resources from one or more LTM candidate cells. Each entry in ltm-CSI-SSB-ResourceList is a CSI RS index.

In some embodiments, the LTM configuration may include an (early) CSI reporting/acquisition/request indication per LTM candidate cell.

In some embodiments, the LTM configuration may include an (early) CSI reporting/acquisition/request indication common for all LTM candidate cells.

In some embodiments, the LTM CSI resource configuration may include an (early) CSI reporting/acquisition/request indication per LTM candidate cell.

In some embodiments, the LTM CSI resource configuration may include an (early) CSI reporting/acquisition/request indication common for all LTM candidate cells.

In some embodiments, the configuration of the LTM candidate cell may include an (early) CSI reporting/acquisition/request indication.

In some embodiments, the LTM configuration may include configuration of LTM CSI resource configurations for (early) CSI acquisition based on CSI-RSs. In some embodiments, the LTM configuration may include configuration of LTM CSI resource configurations for L1 measurements based on CSI-RSs. In some embodiments, the configuration of LTM CSI resource configurations for L1 measurements based on CSI-RSs and the configuration of LTM CSI resource configurations for (early) CSI acquisition based on CSI-RSs can be the same for LTM candidate cells (i.e., LTM CSI resource configurations of LTM candidate cells are signaled which are used for both CSI acquisition and L1 measurements). With separate configurations for CSI acquisition and L1 measurements, the network has the flexibility to configure separate CSI RSs for CSI acquisition and L1 measurements. With the same configuration for CSI acquisition and L1 measurements, CSI RSs for CSI acquisition and L1 measurements are the same. gNB 904 of the serving cell (e.g., Cell A) may receive the configuration of LTM CSI resource configurations for L1 measurements based on CSI-RSs and configuration of LTM CSI resource configurations for (early) CSI acquisition based on CSI-RSs from a CU/DU of the LTM candidate cell(s). gNB 904 of the serving cell (e.g., Cell A) can them combine these and send them to UE 902 in the RRCReconfiguration message.

The RRCReconfiguration of the serving cell and the LTM candidate cell may include an information element (IE) LTM-CSI-ReportConfig for L1 measurement reporting. The IE LTM-CSI-ReportConfig is used to configure an L1 measurement report on the cell in which the LTM-CSI-ReportConfig is included. If the current serving cell (e.g., Cell A) RRCReconfiguration includes the IE LTM-CSI-ReportConfig, the L1 measurement report of the LTM candidate cell(s) is sent to the current serving cell (e.g., Cell A). The IE LTM-CSI-ReportConfig indicates the LTM candidate cell(s) for which the report is sent by including the LTM CSI resource configuration ID. The LTM CSI resource configuration corresponding to the LTM CSI resource configuration ID indicates the LTM candidate cell(s) and RSs for which the report is sent. In some embodiments, the IE LTM-CSI-ReportConfig may indicate whether UE 902 reports CQI and/or PMI and LI and/or RI and/or L1-RSRP of the LTM candidate cell(s).

In some embodiments, the RRCReconfiguration of the serving cell and the LTM candidate cell may include the IE LTM-CSI-ReportConfig for (early) CSI reporting. The IE LTM-CSI-ReportConfig for (early) CSI reporting may indicate whether UE 902 reports CQI and/or PMI and LI and/or RI and/or L1-RSRP of the LTM candidate cell(s).

In some embodiments, (early) CSI acquisition/reporting may be supported only for an intra-distributed unit (DU) scenario. In other words, UE 902 may measure and report CSI (CQI and/or PMI and LI and/or RI) to the serving cell only for the LTM candidate cell(s) belonging to same DU as the serving cell. To enable this, a set ID/group ID/CSI reporting set ID, etc. may be configured for the LTM candidate cell and serving cell, wherein the cells belonging to the same DU are assigned the same set ID/group ID/CSI reporting set ID. If the set ID/group ID/CSI reporting set ID of the serving cell and LTM candidate cell are the same, UE 902 may measure and report the CSI.

In some embodiments, (early) CSI acquisition/reporting may be supported only for an intra-central unit (CU) scenario. In other words, UE 902 may measure and report CSI (CQI and/or PMI and LI and/or RI) to the serving cell only for the LTM candidate cell(s) belonging to the same CU as the serving cell. To enable this, a set ID/group ID/CSI reporting set ID, etc. may be configured for the LTM candidate cell and serving cell, wherein the cells belonging to the same CU are assigned the same set ID/group ID/CSI reporting set ID. If the set ID/group ID/CSI reporting set ID of the serving cell and LTM candidate cell are the same, the UE may measure and report CSI.

In some embodiments, (early) CSI acquisition/reporting may be supported only for a certain group of cells. In these embodiments, a set ID/group ID/CSI reporting set ID, etc. may be configured for the LTM candidate cell and serving cell. If the set ID/group ID/CSI reporting set ID of the serving cell and LTM candidate cell are the same, the UE may measure and report CSI.

In some embodiments, one or more events for (early) CSI acquisition/reporting may be configured in an LTM candidate cell configuration or in a CSI acquisition/reporting configuration of the serving cell. In some embodiments, the (early) CSI acquisition/reporting for an LTM candidate cell is triggered when L1 measurement reporting is triggered for the LTM candidate cell. CSI information (CQI and/or PMI and LI and/or RI) can be included together with the L1 measurement report (e.g., via a MAC CE on a PUSCH or via UCI over a PUCCH/PUSCH).

At operation 930, UE 902 sends an RRCReconfiguration complete message in response to the received RRCReconfiguration message.

At operation 940, UE 902 performs L1 measurements on the configured LTM candidate cell(s) and transmits L1 measurement reports/CSI reports to the serving cell (e.g., Cell A).

In some embodiments, if the LTM configuration of the LTM candidate cell includes an (early) CSI reporting/acquisition/request indication, UE 902 may report CQI and/or PMI and LI and/or RI for the LTM candidate cell in the report.

In some embodiments, if the LTM configuration includes an (early) CSI reporting/acquisition/request indication, UE 902 may report CQI and/or PMI and LI and/or RI for the LTM candidate cell in the report.

In some embodiments, if the LTM CSI resource configuration of the LTM candidate cell includes an (early) CSI reporting/acquisition/request indication, UE 902 may report CQI and/or PMI and LI and/or RI for the LTM candidate cell in the report.

In some embodiments, if the LTM CSI resource configuration includes an (early) CSI reporting/acquisition/request indication, UE 902 may report CQI and/or PMI and LI and/or RI for the LTM candidate cell in the report.

In some embodiments, if LTM-CSI-ReportConfig (or LTM-CSI-ReportConfig for CSI acquisition) indicates that UE 902 reports CQI and/or PMI and LI and/or RI and/or L1-RSRP of LTM candidate cell(s), UE 902 reports CQI and/or PMI and LI and/or RI and/or L1-RSRP of LTM candidate cell(s) in the report.

In some embodiments, if LTM CSI resource configurations for (early) CSI acquisition based on CSI-RSs are received (and/or LTM-CSI-ReportConfig for (early) CSI acquisition from serving cell is received), UE 902 may report CQI and/or PMI and LI and/or RI for the LTM candidate cell in the L1 measurement report or in a CSI report.

In some embodiments, one or more events for (early) CSI acquisition/reporting may be configured in the LTM candidate cell configuration or in the CSI acquisition/reporting configuration of the serving cell. In these embodiments, CSI acquisition/reporting is triggered when the configured event is met. The events can be one or more of Event LTM2: Beam of serving cell becomes worse than absolute threshold; Event LTM3: Beam of candidate cell becomes amount of offset better than beam of serving cell; Event LTM4: Beam of candidate cell becomes better than absolute threshold; Event LTM5: Beam of serving cell becomes worse than absolute threshold1 AND Beam of candidate cell becomes better than another absolute threshold2.

In some embodiments, (early) CSI acquisition/reporting is periodically transmitted after receiving LTM CSI resource configurations for CSI acquisition based on CSI-RSs.

In some embodiments, (early) CSI acquisition/reporting for an LTM candidate cell is triggered when L1 measurement reporting is triggered for the LTM candidate cell. In these embodiments, CSI information (CQI and/or PMI and LI and/or RI) can be included together with the L1 measurement report (e.g., via a MAC CE on a PUSCH or via UCI over a PUCCH/PUSCH).

In some embodiments, UE 902 may receive a CSI request from the serving cell for an LTM candidate cell. The CSI request can be received via a MAC CE or PDCCH or PDCCH order. One MAC CE or PDCCH may include CSI requests for one or more LTM candidate cells. Upon receiving the request, UE 902 reports the CSI of the LTM candidate cell to the serving cell.

In some embodiments, a CSI request may indicate the index of Aperiodic Trigger State configured in LTM-CSI-AperiodicTriggerStateList or a codepoint defined in the MAC CE (LTM-Aperiodic CSI Trigger State Subselection MAC CE). The LTM-Aperiodic CSI Trigger State Subselection MAC CE indicates a subset of trigger states in LTM-CSI-AperiodicTriggerStateList. Each entry in LTM-CSI-AperiodicTriggerStateList, is a list of reporting configuration IDs, where a reporting configuration ID identifies a reporting configuration in ltm-csi-ReportConfigToAddModList. The reporting configuration includes a resource configuration ID which identifies a resource configuration in LTM-csi-ResourceConfigToAddModList. The reporting configuration may indicate CSI-RS resources/candidate cell(s) for which a report is to be sent, may indicate wideband or subband CSI, and may indicate a codebook config. ltm-csi-ReportConfigToAddModList, LTM-csi-ResourceConfigToAddModList and LTM-CSI-AperiodicTriggerStateList may be received in the LTM configuration and/or in the serving cell configuration. ltm-csi-ReportConfigToAddModList, and LTM-CSI-AperiodicTriggerStateList may be received in in the serving cell configuration and LTM-csi-ResourceConfigToAddModList may be received in the LTM configuration. In some embodiments, a CSI request may indicate the reporting configuration ID, where the reporting configuration ID identifies a reporting configuration for CSI reporting.

LTM-CSI-MeasConfig may be configured as follows:

```
LTM-CSI-MeasConfig ::= SEQUENCE {
    ...
    reportTriggerSize INTEGER (0..6) OPTIONAL,
    ltm-aperiodicTriggerStateList SetupRelease { LTM-CSI-AperiodicTriggerStateList },
    ...
}
LTM-CSI-AperiodicTriggerStateList ::= SEQUENCE (SIZE (1..maxNrOfCSI-
AperiodicTriggers))
        OF LTM-CSI-AperiodicTriggerState
LTM-CSI-AperiodicTriggerState ::= SEQUENCE {
  ltm-associatedReportConfigInfoList SEQUENCE
(SIZE(1..maxNrofReportConfigPerAperiodicTrigger))
          OF LTM-CSI-AssociatedReportConfigInfo,
    ...
}
LTM-CSI-AssociatedReportConfigInfo ::= SEQUENCE {
    reportConfigId ltm-CSI-ReportConfigId,
      csi-SSB-ResourceSet INTEGER (1..maxNrofCSI-SSB-ResourceSetsPerConfig)
    },
    ...
}
```

In some embodiments, in a case where Cell A and the LTM candidate cell belong to different DUs of the same gNB, the DU of Cell A can inform the received CQI and/or PMI and/or LI and/or RI and/or L1-RSRP of the LTM candidate cell to the DU of the LTM candidate cell. The DU of the LTM candidate cell may be informed immediately after receipt by the DU of cell A, or may be informed upon a cell switch decision made by cell A.

In some embodiments, in a case where Cell A and the LTM candidate cell belong to different DUs of different gNBs, the DU of Cell A can inform the received CQI and/or PMI and/or LI and/or RI and/or L1-RSRP of the LTM candidate cell to the DU of the LTM candidate cell. The DU of the LTM candidate cell may be informed immediately after receipt by the DU of cell A, or may be informed upon a cell switch decision made by cell A.

The LTM candidate cell or DU of the LTM candidate cell uses the received CQI and/or PMI and LI and/or RI for scheduling when the UE switches to the LTM candidate cell.

At operation 950, the gNB (or base station) 904 of Cell A decides to execute cell switch to an LTM candidate cell (e.g., cell B) and transmits a MAC CE (or DCI) triggering cell switch by including the candidate configuration index of the target cell (i.e., Cell B).

In some embodiments, the MAC CE/DCI may include (early) CSI reporting/acquisition/request indication, and UE 902 may report CQI and/or PMI and LI and/or RI of the LTM candidate cell (e.g., cell B) based on the indication to the LTM candidate cell (e.g., in the first PUSCH/PUCCH transmission to the LTM candidate cell after receiving the MAC CE/DCI triggering cell switch to the LTM candidate cell or in the first PUSCH/PUCCH transmission to the LTM candidate cell after cell switch to the LTM candidate cell is completed or in the [first/earliest] PUSCH/PUCCH transmission to the LTM candidate cell after X ms/slots from the reception of the MAC CE/DCI triggering cell switch to the LTM candidate cell).

In some embodiments, a CSI request in a MAC CE/DCI triggering cell switch may indicate the index of an Aperiodic Trigger State configured in LTM-CSI-AperiodicTriggerStateList or codepoint defined in the MAC CE (LTM-Aperiodic CSI Trigger State Subselection MAC CE). LTM-Aperiodic CSI Trigger State Subselection MAC CE indicates a subset of trigger states in LTM-CSI-AperiodicTriggerStateList. Each entry in LTM-CSI-AperiodicTriggerStateList, is a list of reporting configuration IDs where a reporting configuration ID identifies a reporting configuration in ltm-csi-ReportConfigToAddModList. A reporting configuration include a resource configuration ID which identifies a resource configuration in LTM-csi-ResourceConfigToAddModList. A reporting configuration may indicate CSI-RS resources/candidate cell(s) for which a report is to be sent, may indicate wideband or subband CSI, and may indicate a codebook config. ltm-csi-ReportConfigToAddModList, LTM-csi-ResourceConfigToAddModList and LTM-CSI-AperiodicTriggerStateList may be received in the LTM configuration and/or in the serving cell configuration. ltm-csi-ReportConfigToAddModList, and LTM-CSI-AperiodicTriggerStateList may be received in in the serving cell configuration and LTM-csi-ResourceConfigToAddModList may be received in the LTM configuration.

In some embodiments, a CSI request in a MAC CE/DCI or MAC CE/DCI triggering cell switch may indicate a reporting configuration ID, where the reporting configuration ID identifies a reporting configuration for CSI reporting.

In some embodiments, a MAC CE/DCI triggering cell switch may indicate a reporting quantity such as CQI and/or PMI and/or LI and/or RI and/or L1-RSRP of an LTM candidate cell to be reported. The CSI request in the MAC CE/DCI triggering cell switch may be included only for a RACH less LTM cell switch (i.e., not included for a RACH based LTM cell switch) or for the case TA is included in the MAC CE/DCI triggering cell switch (i.e., not included for the case TA is not included in MAC CE/DCI triggering cell switch).

In some embodiments, if the LTM configuration of the LTM candidate cell includes an (early) CSI reporting/acquisition/request indication, UE 902 may report CQI and/or PMI and LI and/or RI of the LTM candidate cell (e.g., cell B) to the LTM candidate cell (e.g., in the first PUSCH/PUCCH transmission to LTM candidate cell after receiving MAC CE/DCI triggering cell switch to the LTM candidate cell or in the first PUSCH/PUCCH transmission to the LTM candidate cell after cell switch to the LTM candidate cell is completed or in the [first/earliest] PUSCH/PUCCH transmission to the LTM candidate cell after X ms/slots from the reception of the MAC CE/DCI triggering cell switch to the LTM candidate cell).

In some embodiments, if the LTM configuration of the LTM candidate cell includes an (early) CSI reporting/acquisition/request indication, UE 902 may report CQI and/or PMI and LI and/or RI of the LTM candidate cell (e.g., cell B) to the LTM candidate cell (e.g., in the first PUSCH/PUCCH transmission to the LTM candidate cell after receiving the MAC CE/DCI triggering cell switch to the LTM candidate cell or in the first PUSCH/PUCCH transmission to the LTM candidate cell after cell switch to the LTM candidate cell is completed or in the [first/earliest] PUSCH/PUCCH transmission to the LTM candidate cell after X ms/slots from the reception of MAC CE/DCI triggering cell switch to the LTM candidate cell).

In some embodiments, if the LTM CSI resource configuration of the LTM candidate cell includes an (early) CSI reporting/acquisition/request indication, UE 902 may report CQI and/or PMI and LI and/or RI for the LTM candidate cell (e.g., cell B) to the LTM candidate cell (e.g., in the first PUSCH/PUCCH transmission to the LTM candidate cell after receiving the MAC CE/DCI triggering cell switch to the LTM candidate cell or in the first PUSCH/PUCCH transmission to the LTM candidate cell after cell switch to the LTM candidate cell is completed or in the [first/earliest] PUSCH/PUCCH transmission to the LTM candidate cell after X ms/slots from the reception of the MAC CE/DCI triggering cell switch to the LTM candidate cell).

In some embodiments, if the LTM CSI resource configuration includes an (early) CSI reporting/request indication, UE 902 may report CQI and/or PMI and LI and/or RI for the LTM candidate cell (e.g., cell B) to the LTM candidate cell (e.g., in the first PUSCH/PUCCH transmission to the LTM candidate cell after receiving the MAC CE/DCI triggering cell switch to the LTM candidate cell or in the first PUSCH/PUCCH transmission to the LTM candidate cell after cell switch to the LTM candidate cell is completed or in the [first/earliest] PUSCH/PUCCH transmission to LTM candidate cell after X ms/slots from the reception of the MAC CE/DCI triggering cell switch to the LTM candidate cell).

In some embodiments, if LTM CSI resource configurations for CSI acquisition based on CSI-RSs are received (and/or LTM-CSI-ReportConfig for CSI acquisition from the serving cell is received), UE 902 may report CQI and/or PMI and LI and/or RI for the LTM candidate cell to the candidate cell (e.g., in the first PUSCH/PUCCH transmission to the LTM candidate cell after receiving the MAC CE/DCI triggering cell switch to the LTM candidate cell or in the first PUSCH/PUCCH transmission to the LTM candidate cell after cell switch to the LTM candidate cell is completed or in the [first/earliest] PUSCH/PUCCH transmission to the LTM candidate cell after X ms/slots from the reception of the MAC CE/DCI triggering cell switch to the LTM candidate cell).

At operation 960, UE 902 switches to target cell B and applies the configuration indicated by the candidate configuration index (at operation 910, UE 902 may receive an LTM configuration of multiple candidate cells and each configuration is identified by a candidate configuration index). UE 902 completes the LTM cell switch procedure by sending an RRCReconfigurationComplete message to target cell B (i.e., gNB 906).

In some embodiments, a CSI request can be included in a conditional handover (CHO) configuration (per cell or common for all cells) or in an LTM configuration (per cell or common for all cells) for conditional LTM. Based on the indication, UE 902 can send CSI after selecting a cell for CHO or UE 902 can send/initiate CSI reporting when a conditional LTM cell switch is triggered to a LTM target/candidate cell. The CSI reporting configuration ID and/or CSI reporting configuration for this CSI reporting can be signaled in an LTM configuration (per cell or common for all cells). The CSI reporting configuration ID and/or CSI reporting configuration and/or CSI request for early CSI reporting can be indicated by the serving cell/gNB 904 in a MAC CE (e.g., an early TA MAC CE or DL TCI state Subselection MAC CE for LTM or a new MAC CE) or DCI before the conditional LTM cell switch, and if the CSI reporting configuration ID and/or CSI reporting configuration and/or CSI request for early CSI reporting is received in the MAC CE for LTM candidate/target cell for which conditional LTM cell switch trigger condition is met, UE 902 can send/initiate CSI reporting to the LTM candidate/target cell. In some embodiments, the CSI reporting configuration ID and/or CSI reporting configuration and/or CSI request for early CSI reporting can be indicated by the serving cell/gNB 904 in a MAC CE (e.g., an early TA MAC CE or DL TCI state Subselection MAC CE for LTM or a new MAC CE) or DCI, in response to a notification sent by UE 902 when a conditional LTM cell switch trigger condition is met.

Although FIG. 9 illustrates one example procedure 900 for CSI reporting/acquisition during a lower layer triggered mobility procedure, various changes may be made to FIG. 9. For example, while shown as a series of operations, various operations in FIG. 9 could overlap, occur in parallel, occur in a different order, occur any number of times, be omitted, or replaced by other operations.

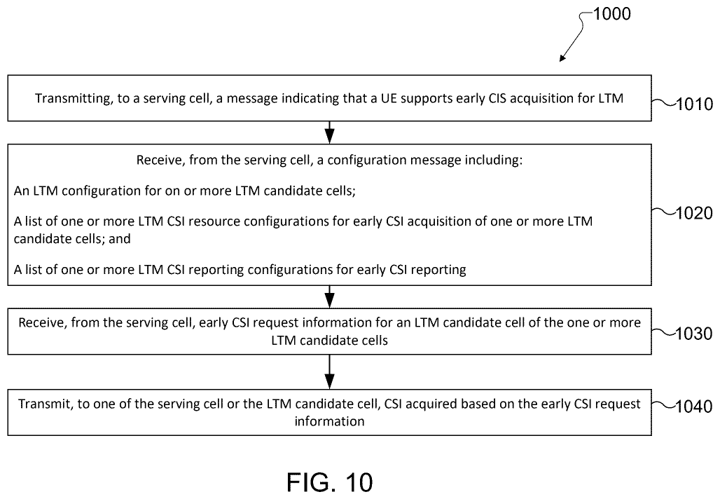

FIG. 10 illustrates an example method 1000 for configuring resources for beam reporting according to embodiments of the present disclosure. An embodiment of the method illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of a method for configuring resources for beam reporting could be used without departing from the scope of this disclosure.

In the example of FIG. 10, method 1000 begins at step 1010. At step 1010, a UE (such as UE 116 of FIG. 1) transmits, to a serving cell, a message indicating that the UE supports early CSI acquisition for LTM.

At step 1020, the UE receives, from the serving cell, a configuration message. The configuration message includes (i) an LTM configuration for one or more LTM candidate cells, (ii) a list of one or more LTM CSI resource configurations for early CSI acquisition of one or more LTM candidate cells, and (iii) a list of one or more LTM CSI reporting configurations for early CSI reporting.

At step 1030, the UE receives, from the serving cell, early CSI request information for an LTM candidate cell of the one or more LTM candidate cells. In some embodiments, the early CSI request information may be at least one of an LTM CSI reporting configuration identity and an index of an aperiodic trigger state amongst a list of aperiodic trigger states received in the LTM configuration. In some embodiments, the early CSI request information may be included in the LTM configuration for one or more LTM candidate cells (i.e., at step 1020).

At step 1040, the UE transmits, to one of the serving cell or the LTM candidate cell, CSI acquired based on the early CSI request information.

In some embodiments, the early CSI request information for an LTM candidate cell is received (i.e., at step 1030) before an LTM cell switch to the LTM candidate cell is triggered. In these embodiments, the CSI acquired based on the early CSI request information may be transmitted (i.e., at step 1040) to the serving cell.

In some embodiments, the UE may receive an LTM cell switch command triggering an LTM cell switch to the LTM candidate cell, and determine whether the early CSI request information for the LTM candidate cell is included in the LTM cell switch command. In other words, the LTM cell switch command may be received at step 1030, and the UE may determine at step 1030 whether the LTM cell switch command includes the CSI request information for the LTM candidate cell. In these embodiments, the CSI acquired based on the early CSI request information may be transmitted (i.e., at step 1040) to the LTM candidate cell in response to a determination that the early CSI request information for the LTM candidate cell is included in the LTM cell switch command.

In some embodiments, the UE may receive an LTM cell switch command triggering an LTM cell switch to the LTM candidate cell, and determine whether an LTM CSI resource configuration for the LTM candidate cell is included in the configuration message received at step 1020. In these embodiments, the CSI acquired may be transmitted (i.e., at step 1040) to the LTM candidate cell in response to a determination that the LTM CSI resource configuration for the LTM candidate cell is included in the configuration message. In some embodiments, the CSI may be transmitted to the LTM candidate cell in one of a first PUSCH or PUCCH transmission to the LTM candidate cell after one of (i) reception of the LTM cell switch command, (ii) a time interval from reception of the LTM cell switch command, and (iii) cell switch to the LTM candidate cell is completed.

Although FIG. 10 illustrates one example method 1000 for configuring resources for beam reporting, various changes may be made to FIG. 10. For example, while shown as a series of steps, various steps in FIG. 10 could overlap, occur in parallel, occur in a different order, occur any number of times, be omitted, or replaced by other steps.

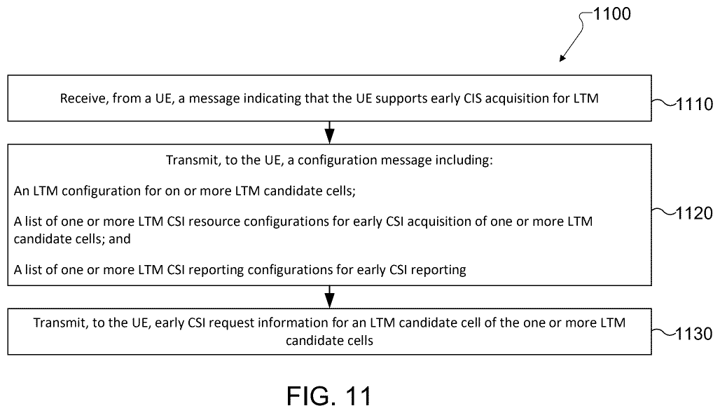

FIG. 11 illustrates another example method 1100 for configuring resources for beam reporting according to embodiments of the present disclosure. An embodiment of the method illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of a method for configuring resources for beam reporting could be used without departing from the scope of this disclosure.

In the example of FIG. 11, method 1100 begins at step 1110. At step 1110, a BS (such as gNB 102 of FIG. 1) receives, from a UE (such as UE 116 of FIG. 1), a message indicating that the UE supports early CSI acquisition for LTM.

At step 1120, the BS transmits, to the UE, a configuration message. The configuration message includes (i) an LTM configuration for one or more LTM candidate cells, (ii) a list of one or more LTM CSI resource configurations for early CSI acquisition of one or more LTM candidate cells, and (iii) a list of one or more LTM CSI reporting configurations for early CSI reporting.

At step 1130, the BS transmits, to the UE, early CSI request information for an LTM candidate cell of the one or more LTM candidate cells. In some embodiments, the early CSI request information may be at least one of an LTM CSI reporting configuration identity and an index of an aperiodic trigger state amongst a list of aperiodic trigger states received in the LTM configuration. In some embodiments, the early CSI request information may be included in the LTM configuration for one or more LTM candidate cells (i.e., at step 1120).

In some embodiments, the early CSI request information for an LTM candidate cell may be transmitted (i.e., at step 1130) before an LTM cell switch to the LTM candidate cell is triggered. In these embodiments, BS may receive, from the UE, CSI acquired based on the early CSI request information.

In some embodiments, the BS may transmit an LTM cell switch command triggering an LTM cell switch to the LTM candidate cell. In these embodiments, the early CSI request information for the LTM candidate cell may be included in the LTM cell switch command (i.e., at step 1130).

In some embodiments, the BS may transmit an LTM cell switch command triggering an LTM cell switch to the LTM candidate cell. In these embodiments, an LTM CSI resource configuration for the LTM candidate cell may included in the configuration message (i.e., at step 1120).

Although FIG. 11 illustrates one example method 1100 for configuring resources for beam reporting, various changes may be made to FIG. 11. For example, while shown as a series of steps, various steps in FIG. 11 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a processor; and
a transceiver operably coupled to the processor, the transceiver configured to:
transmit, to a serving cell, a message indicating that the UE supports early channel state information (CSI) acquisition for layer one triggered mobility (LTM);
receive, from the serving cell, a configuration message including:
an LTM configuration for one or more LTM candidate cells;
a list of one or more LTM CSI resource configurations for early CSI acquisition of one or more LTM candidate cells; and
a list of one or more LTM CSI reporting configurations for early CSI reporting;
receive, from the serving cell, early CSI request information for an LTM candidate cell of the one or more LTM candidate cells; and
transmit, to one of the serving cell or the LTM candidate cell, CSI acquired based on the early CSI request information.

2. The UE of claim 1, wherein the early CSI request information is included in the LTM configuration for the one or more LTM candidate cells.

3. The UE of claim 1, wherein the early CSI request information is at least one of:
an LTM CSI reporting configuration identity; and
an index of an aperiodic trigger state amongst a list of aperiodic trigger states received in the LTM configuration.

4. The UE of claim 1, wherein:
the early CSI request information for an LTM candidate cell is received before an LTM cell switch to the LTM candidate cell is triggered; and
the CSI acquired based on the early CSI request information is transmitted to the serving cell.

5. The UE of claim 1, wherein:
the transceiver is further configured to receive an LTM cell switch command triggering an LTM cell switch to the LTM candidate cell;
the processor is configured to determine whether the early CSI request information for the LTM candidate cell is included in the LTM cell switch command; and
the CSI acquired based on the early CSI request information is transmitted to the LTM candidate cell in response to a determination that the early CSI request information for the LTM candidate cell is included in the LTM cell switch command.

6. The UE of claim 1, wherein:
the transceiver is further configured to receive an LTM cell switch command triggering an LTM cell switch to the LTM candidate cell;
the processor is configured to determine whether an LTM CSI resource configuration for the LTM candidate cell is included in the configuration message; and
the CSI acquired is transmitted to the LTM candidate cell in response to a determination that the LTM CSI resource configuration for the LTM candidate cell is included in the configuration message.

7. The UE of claim 6, wherein the transceiver is further configured to transmit the CSI of the LTM candidate cell in a first physical uplink shared channel (PUSCH) transmission to the LTM candidate cell after one of:
reception of the LTM cell switch command;
a time interval from reception of the LTM cell switch command; and
cell switch to the LTM candidate cell is completed.

8. The UE of claim 6, wherein the transceiver is further configured to transmit the CSI of the LTM candidate cell in a first physical uplink control channel (PUCCH) transmission to the LTM candidate cell after one of:
reception of the LTM cell switch command;
a time interval from reception of the LTM cell switch command; and
cell switch to the LTM candidate cell is completed.

9. A base station (BS) comprising:
a processor; and
a transceiver operably coupled to the processor, the transceiver configured to:
receive, from a user equipment (UE), a message indicating that the UE supports early channel state information (CSI) acquisition for layer one triggered mobility (LTM);
transmit, to the UE, a configuration message including:
an LTM configuration for one or more LTM candidate cells;
a list of one or more LTM CSI resource configurations for early CSI acquisition of one or more LTM candidate cells; and
a list of one or more LTM CSI reporting configurations for early CSI reporting; and
transmit, to the UE, early CSI request information for an LTM candidate cell of the one or more LTM candidate cells.

10. The BS of claim 9, wherein the early CSI request information is included in the LTM configuration for the one or more LTM candidate cells.

11. The BS of claim 9, wherein the early CSI request information is at least one of:
an LTM CSI reporting configuration identity; and
an index of an aperiodic trigger state amongst a list of aperiodic trigger states received in the LTM configuration.

12. The BS of claim 9, wherein:
the early CSI request information for an LTM candidate cell is transmitted before an LTM cell switch to the LTM candidate cell is triggered; and
the transceiver is further configured to receive, from the UE, CSI acquired based on the early CSI request information.

13. The BS of claim 9, wherein:
the transceiver is further configured to transmit an LTM cell switch command triggering an LTM cell switch to the LTM candidate cell; and
the early CSI request information for the LTM candidate cell is included in the LTM cell switch command.

14. The BS of claim 9, wherein:
the transceiver is further configured to transmit an LTM cell switch command triggering an LTM cell switch to the LTM candidate cell; and
an LTM CSI resource configuration for the LTM candidate cell is included in the configuration message.

15. A method of operating a user equipment (UE), the method comprising:
transmitting, to a serving cell, a message indicating that the UE supports early channel state information (CSI) acquisition for layer one triggered mobility (LTM);
receiving from the serving cell, a configuration message including:
an LTM configuration for one or more LTM candidate cells;
a list of one or more LTM CSI resource configurations for early CSI acquisition of one or more LTM candidate cells; and
a list of one or more LTM CSI reporting configurations for early CSI reporting;
receiving, from the serving cell, early CSI request information for an LTM candidate cell of the one or more LTM candidate cells; and
transmitting, to one of the serving cell or the LTM candidate cell, CSI acquired based on the early CSI request information.

16. The method of claim 15, wherein the early CSI request information is at least one of:
an LTM CSI reporting configuration identity; and
an index of an aperiodic trigger state amongst a list of aperiodic trigger states received in the LTM configuration.

17. The method of claim 15, wherein:
the early CSI request information for an LTM candidate cell is received before an LTM cell switch to the LTM candidate cell is triggered; and
the CSI acquired based on the early CSI request information is transmitted to the serving cell.

18. The method of claim 15, further comprising:
receiving an LTM cell switch command triggering an LTM cell switch to the LTM candidate cell; and
determining whether the early CSI request information for the LTM candidate cell is included in the LTM cell switch command,
wherein the CSI acquired based on the early CSI request information is transmitted to the LTM candidate cell in response to a determination that the early CSI request information for the LTM candidate cell is included in the LTM cell switch command.

19. The method of claim 15, further comprising:
receiving an LTM cell switch command triggering an LTM cell switch to the LTM candidate cell; and
determining whether an LTM CSI resource configuration for the LTM candidate cell is included in the configuration message,
wherein the CSI acquired is transmitted to the LTM candidate cell in response to a determination that the LTM CSI resource configuration for the LTM candidate cell is included in the configuration message.

20. The method of claim 19, wherein the CSI is transmitted to the LTM candidate cell in one of a first physical uplink shared channel (PUSCH) or physical uplink control channel (PUCCH) transmission to the LTM candidate cell after one of:
reception of the LTM cell switch command;
a time interval from reception of the LTM cell switch command; and
cell switch to the LTM candidate cell is completed.
